(19) United States
(12) Patent Application Publication
(10) Pub. No.: US 2025/0373271 A1
(43) Pub. Date: Dec. 4, 2025

(54) RADIO FREQUENCY FRONT-END ARCHITECTURES

(71) Applicant: Skyworks Solutions, Inc., Irvine, CA (US)

(72) Inventor: Anand Raghavan, Middleton, WI (US)

(21) Appl. No.: 19/225,177

(22) Filed: Jun. 2, 2025

Related U.S. Application Data
(60) Provisional application No. 63/655,708, filed on Jun. 4, 2024.
(60) Provisional application No. 63/800,275, filed on May 5, 2025.

(51) Int. Cl. H04B 1/00; H04B 1/40; H04W 84/12

(52) U.S. Cl. CPC H04B 1/0064; H04B 1/40; H04W 84/12

(57) ABSTRACT

Apparatus and methods for radio frequency front-end architectures are disclosed. In certain embodiments, radio frequency front-ends (RFFEs) are disclosed with a high level of integration and component reuse for antennas, power amplifiers (PAs), low noise amplifiers (LNAs), filters, and/or modules. For instance, 2 RFFE modules and 6 antennas can cover all sub-7 GHz frequency bands. Such frequency bands can include not only cellular frequency bands, but also frequency bands for WiFi and/or cellular vehicle-to-everything (CV2X).

### CROSS-REFERENCE TO RELATED APPLICATIONS

This application claims the benefit of priority under 35 U.S.C. § 119 of U.S. Provisional Patent Application No. 63/655,708, filed Jun. 4, 2024 and titled “RADIO FREQUENCY FRONT-END ARCHITECTURES,” and of U.S. Provisional Patent Application No. 63/800,275, filed May 5, 2025 and titled “RADIO FREQUENCY FRONT-END ARCHITECTURES,” each of which is herein incorporated by reference in its entirety.

### BACKGROUND

### Field

Embodiments of the invention relate to electronic systems, and in particular, to radio frequency electronics.

### Description of Related Technology

Radio frequency (RF) communication systems can be used for transmitting and/or receiving signals of a wide range of frequencies. For example, an RF communication system can be used to wirelessly communicate RF signals in a frequency range of about 30 kHz to 300 GHz, such as in the range of about 400 MHz to about 7.125 GHz for Frequency Range 1 (FR1) of the Fifth Generation (5G) communication standard or in the range of about 24.250 GHz to about 71.000 GHz for Frequency Range 2 (FR2) of the 5G communication standard.

Examples of RF communication systems include, but are not limited to, mobile phones, tablets, base stations, network access points, customer-premises equipment (CPE), laptops, and wearable electronics.

### SUMMARY

In certain embodiments, the present disclosure relates to a mobile device. The mobile device includes a plurality of antennas including a first antenna, a second antenna, and a third antenna. The mobile device further includes a front-end system including a first antenna-plexer coupled to the first antenna and configured to handle a first cellular frequency band and a first wireless local area network band, a second antenna-plexer coupled to the second antenna and configured to handle a second cellular frequency band and a second wireless local area network band, and a third antenna-plexer coupled to the third antenna and configured to handle the first cellular frequency band and the second cellular frequency band.

In some embodiments, the first cellular frequency band is n77 and the second cellular frequency band is n79.

In various embodiments, the first wireless local area network band is a WiFi 5 gigahertz band and the second wireless local area network band is a WiFi 6 gigahertz band.

In several embodiments, the first antenna-plexer has a high corner for the first wireless local area network band that is tunable.

In some embodiments, the third antenna-plexer further supports a third cellular frequency band. According to a number of embodiments, the third cellular frequency band is n104 and the second wireless local area network band is a WiFi 6 gigahertz band. In accordance with several embodiments, the front-end system includes at least one of a shared power amplifier or a shared low noise amplifier for amplifying n104 and the WiFi 6 gigahertz band. According to various embodiments, the third antenna-plexer has a low corner for n104 that is tunable.

In several embodiments, the first antenna-plexer is a first diplexer, the second antenna-plexer is a second diplexer, and the third antenna-plexer is a triplexer.

In various embodiments, the plurality of antennas further includes a fourth antenna, a fifth antenna, and a sixth antenna, and the front-end system further includes a fourth antenna-plexer coupled to the fourth antenna and configured to handle the first cellular frequency band and the first wireless local area network band, a fifth antenna-plexer coupled to the fifth antenna and configured to handle the second cellular frequency band and the second first wireless local area network band, and a sixth antenna-plexer coupled to the sixth antenna and configured to handle the first cellular frequency band and the second cellular frequency band.

In certain embodiments, the present disclosure relates to a method of radio frequency communication. The method includes using a plurality of antennas to communicate over a first cellular frequency band, a first wireless local area network band, a second cellular frequency band, and a second wireless local area network band, the plurality of antennas including a first antenna, a second antenna, and a third antenna. The method further includes providing multiplexing of the first cellular frequency band and the first wireless local area network band using a first antenna-plexer coupled to the first antenna, providing multiplexing of the second cellular frequency band the second wireless local area network band using a second antenna-plexer coupled to the second antenna, and providing multiplexing of the first cellular frequency band and the second cellular frequency band using a third antenna-plexer coupled to the third antenna.

In some embodiments, the first cellular frequency band is n77 and the second cellular frequency band is n79.

In various embodiments, the first wireless local area network band is a WiFi 5 gigahertz band and the second wireless local area network band is a WiFi 6 gigahertz band.

In several embodiments, the first antenna-plexer has a high corner for the first wireless local area network band that is tunable.

In some embodiments, the third antenna-plexer further supports a third cellular frequency band. According to a number of embodiments, the third cellular frequency band is n104. In accordance with several embodiments, the third antenna-plexer has a low corner for n104 that is tunable.

In various embodiments, the first antenna-plexer is a first diplexer, the second antenna-plexer is a second diplexer, and the third antenna-plexer is a triplexer.

In some embodiments, the plurality of antennas further includes a fourth antenna, a fifth antenna, and a sixth antenna, and the method further includes using a fourth antenna-plexer that is coupled to the fourth antenna to handle the first cellular frequency band the first wireless local area network band, using a fifth antenna-plexer that is coupled to the fifth antenna to handle the second cellular frequency band and the second wireless local area network band, and using a sixth antenna-plexer coupled to the sixth antenna to handle the first cellular frequency band and the second cellular frequency band.

In certain embodiments, the present disclosure relates to a front-end system for a mobile device. The front-end system includes a first antenna-plexer configured to couple to a first antenna and operable to handle a first cellular frequency band and a first wireless local area network band, a second antenna-plexer configured to couple to a second antenna and operable to handle a second cellular frequency band and a second wireless local area network band, and a third antenna-plexer configured to coupled to a third antenna and operable to handle the first cellular frequency band and the second cellular frequency band.

In various embodiments, the first wireless local area network band is a WiFi 5 gigahertz band and the second wireless local area network band is a WiFi 6 gigahertz band.

In some embodiments, the first cellular frequency band is n77 and the second cellular frequency band is n79. According to a number of embodiments, the first antenna-plexer has a high corner for the first wireless local area network band that is tunable.

In several embodiments, the third antenna-plexer further supports a third cellular frequency band. According to a number of embodiments, the third cellular frequency band is n104 and the second wireless local area network is a WiFi 6 gigahertz band. In accordance with some embodiments, the front-end system includes at least one of a shared power amplifier or a shared low noise amplifier for amplifying n104 and the WiFi 6 gigahertz band. According to various embodiments, the third antenna-plexer has a low corner for n104 that is tunable.

In some embodiments, the first antenna-plexer is a first diplexer, the second antenna-plexer is a second diplexer, and the third antenna-plexer is a triplexer.

In various embodiments, the front-end system further includes a fourth antenna-plexer configured to couple to a fourth antenna and operable to handle the first cellular frequency band and the first wireless local area network band, a fifth antenna-plexer configured to couple to a fifth antenna and operable to handle the second cellular frequency band and the second wireless local area network band, and a sixth antenna-plexer configured to couple to a sixth antenna and operable to handle the first cellular frequency band and the second cellular frequency band.

In certain embodiments, the present disclosure relates to a mobile device. The mobile device includes a plurality of antennas including a first antenna configured to handle an n77 cellular frequency band, a second antenna configured to handle an n79 cellular frequency band, and a third antenna configured to handle an n104 cellular frequency band. The mobile device further includes a front-end system including a first module coupled to the first antenna, the second antenna, and the third antenna, the first module configured to handle the n77 cellular frequency band, the n79 cellular frequency band, and the n104 cellular frequency band.

In some embodiments, the first module includes a triplexer that multiplexes the n77 cellular frequency band, the n79 cellular frequency band, and the n104 cellular frequency band. According to a number of embodiments, the first module further includes a diplexer that multiplexes the n77 cellular frequency band and the n79 cellular frequency band. In accordance with several embodiments, the first module further includes an auxiliary terminal for coupling to the third antenna through a WiFi module. According to various embodiments, the first module further includes a diplexer that multiplexes the n77 cellular frequency band and a WiFi frequency band.

In several embodiments, the first module includes an n77 power amplifier, an n79 power amplifier, and an n104 power amplifier.

In various embodiments, the first module includes a pair of n77 low noise amplifiers, a pair of n79 low noise amplifiers, and a pair of n104 low noise amplifiers.

In certain embodiments, the present disclosure relates to a method of handling radio frequency signals in a mobile device. The method includes communicating over an n77 cellular frequency band using a first antenna, communicating over an n79 cellular frequency band using a second antenna, communicating over an n104 cellular frequency band using a third antenna, and processing signals from the first antenna, the second antenna, and the third antenna using a first module of the front-end system, the first module handling the n77 cellular frequency band, the n79 cellular frequency band, and the n104 cellular frequency band.

In various embodiments, the first module includes a triplexer that multiplexes the n77 cellular frequency band, the n79 cellular frequency band, and the n104 cellular frequency band. According to a number of embodiments, the first module further includes a diplexer that multiplexes the n77 cellular frequency band and the n79 cellular frequency band. In accordance with several embodiments, the first module further includes an auxiliary terminal for coupling to the third antenna through a WiFi module. According to some embodiments, the first module further includes a diplexer that multiplexes the n77 cellular frequency band and a WiFi frequency band. In accordance with a number of embodiments, the first module includes an n77 power amplifier, an n79 power amplifier, and an n104 power amplifier.

In several embodiments, the first module includes a pair of n77 low noise amplifiers, a pair of n79 low noise amplifiers, and a pair of n104 low noise amplifiers.

In certain embodiments, the present disclosure relates to a module for a front-end system. The module includes a first antenna terminal configured to couple to a first antenna that communicates over an n77 cellular frequency band, a second antenna terminal configured to couple to a second antenna that communicates over an n79 cellular frequency band, and a third antenna terminal configured to couple to a third antenna configured to handle an n104 cellular frequency band, the front-end system, the module configured to handle the n77 cellular frequency band, the n79 cellular frequency band, and the n104 cellular frequency band.

In various embodiments, the module further includes a triplexer that multiplexes the n77 cellular frequency band, the n79 cellular frequency band, and the n104 cellular frequency band. According to a number of embodiments, the first module further includes a diplexer that multiplexes the n77 cellular frequency band and the n79 cellular frequency band. In accordance with several embodiments, the module further includes an auxiliary terminal for coupling to the third antenna through a WiFi module. According to some embodiments, the module further includes a diplexer that multiplexes the n77 cellular frequency band and a WiFi frequency band.

In several embodiments, the module further includes an n77 power amplifier, an n79 power amplifier, and an n104 power amplifier.

In some embodiments, the module further includes a pair of n77 low noise amplifiers, a pair of n79 low noise amplifiers, and a pair of n104 low noise amplifiers.

### BRIEF DESCRIPTION OF THE DRAWINGS

FIG. 1 is a schematic diagram of one example of a communication network.

FIG. 2A is a schematic diagram of one example of a communication link using carrier aggregation.

FIG. 2B illustrates various examples of uplink carrier aggregation for the communication link of FIG. 2A.

FIG. 2C illustrates various examples of downlink carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 3C is schematic diagram of another example of an uplink channel using MIMO communications.

FIG. 4 is a schematic diagram of an example dual connectivity network topology.

FIG. 5A is a schematic diagram of one example of a communication system that operates with beamforming.

FIG. 5B is a schematic diagram of one example of beamforming to provide a transmit beam.

FIG. 5C is a schematic diagram of one example of beamforming to provide a receive beam.

FIG. 6A is a schematic diagram of one embodiment of a front-end system.

FIG. 6B is a schematic diagram of another embodiment of a front-end system.

FIG. 6C is a schematic diagram of another embodiment of a front-end system.

FIG. 6D is a schematic diagram of another embodiment of a front-end system.

FIG. 6E is a schematic diagram of another embodiment of a front-end system.

FIG. 6F is a schematic diagram of another embodiment of a front-end system.

FIG. 7A is a schematic diagram of another embodiment of a front-end system.

FIG. 7B is a schematic diagram of another embodiment of a front-end system.

FIG. 7C is a schematic diagram of another embodiment of a front-end system.

FIG. 7D is a schematic diagram of another embodiment of a front-end system.

FIG. 7E is a schematic diagram of another embodiment of a front-end system.

FIG. 7F is a schematic diagram of another embodiment of a front-end system.

FIG. 8 is a schematic diagram of one embodiment of a mobile device.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and introduced Phase 2 of 5G technology in Release 16. Subsequent 3GPP releases will further evolve and expand 5G technology. 5G technology is also referred to herein as 5G New Radio (NR).

5G NR supports or plans to support a variety of features, such as communications over millimeter wave spectrum, beamforming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

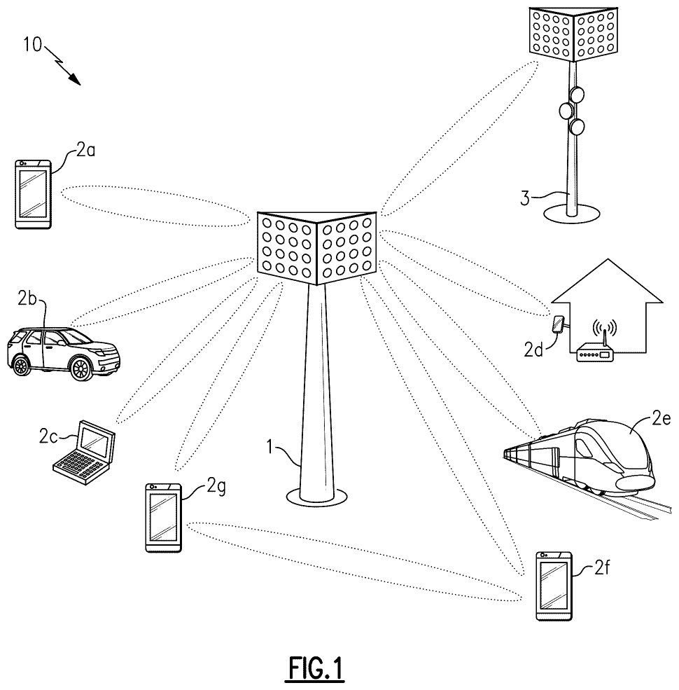

FIG. 1 is a schematic diagram of one example of a communication network 10. The communication network 10 includes a macro cell base station 1, a small cell base station 3, and various examples of user equipment (UE), including a first mobile device 2a, a wireless-connected car 2b, a laptop 2c, a stationary wireless device 2d, a wireless-connected train 2e, a second mobile device 2f, and a third mobile device 2g.

Although specific examples of base stations and user equipment are illustrated in FIG. 1, a communication network can include base stations and user equipment of a wide variety of types and/or numbers.

For instance, in the example shown, the communication network 10 includes the macro cell base station 1 and the small cell base station 3. The small cell base station 3 can operate with relatively lower power, shorter range, and/or with fewer concurrent users relative to the macro cell base station 1. The small cell base station 3 can also be referred to as a femtocell, a picocell, or a microcell. Although the communication network 10 is illustrated as including two base stations, the communication network 10 can be implemented to include more or fewer base stations and/or base stations of other types.

Although various examples of user equipment are shown, the teachings herein are applicable to a wide variety of user equipment, including, but not limited to, mobile phones, tablets, laptops, IoT devices, wearable electronics, customer premises equipment (CPE), wireless-connected vehicles, wireless relays, and/or a wide variety of other communication devices. Furthermore, user equipment includes not only currently available communication devices that operate in a cellular network, but also subsequently developed communication devices that will be readily implementable with the inventive systems, processes, methods, and devices as described and claimed herein.

The illustrated communication network 10 of FIG. 1 supports communications using a variety of cellular technologies, including, for example, 4G LTE and 5G NR. In certain implementations, the communication network 10 is further adapted to provide a wireless local area network (WLAN), such as WiFi (also known as IEEE 802.11 or Wi-Fi). Although various examples of communication technologies have been provided, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

In certain implementations, user equipment can communicate with a base station using one or more of 4G LTE, 5G NR, and WiFi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed WiFi frequencies).

As shown in FIG. 1, the communication links include not only communication links between UE and base stations, but also UE to UE communications and base station to base station communications. For example, the communication network 10 can be implemented to support self-fronthaul and/or self-backhaul.

The communication links can operate over a wide variety of frequencies. In certain implementations, communications are supported using 5G NR technology over one or more frequency bands that are less than 6 Gigahertz (GHz) and/or over one or more frequency bands that are greater than 6 GHz. For example, the communication links can serve Frequency Range 1 (FR1), Frequency Range 2 (FR2), or a combination thereof. In one embodiment, one or more of the mobile devices support a HPUE power class specification.

In certain implementations, a base station and/or user equipment communicates using beamforming. For example, beamforming can be used to focus signal strength to overcome path losses, such as high loss associated with communicating over high signal frequencies. In certain embodiments, user equipment, such as one or more mobile phones, communicate using beamforming on millimeter wave frequency bands in the range of 30 GHz to 300 GHz and/or upper centimeter wave frequencies in the range of 6 GHz to 30 GHz, or more particularly, 24 GHz to 30 GHz. Cellular user equipment can communicate using beamforming and/or other techniques over a wide range of frequencies, including, for example, FR2-1 (24 GHz to 52 GHz), FR2-2 (52 GHz to 71 GHz), and/or FR1 (400 MHz to 7125 MHz).

Different users of the communication network 10 can share available network resources, such as available frequency spectrum, in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDMA is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user a unique code, space-divisional multiple access (SDMA) in which beamforming is used to provide shared access by spatial division, and non-orthogonal multiple access (NOMA) in which the power domain is used for multiple access. For example, NOMA can be used to serve multiple users at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to, eMBB, uRLLC, and/or mMTC.

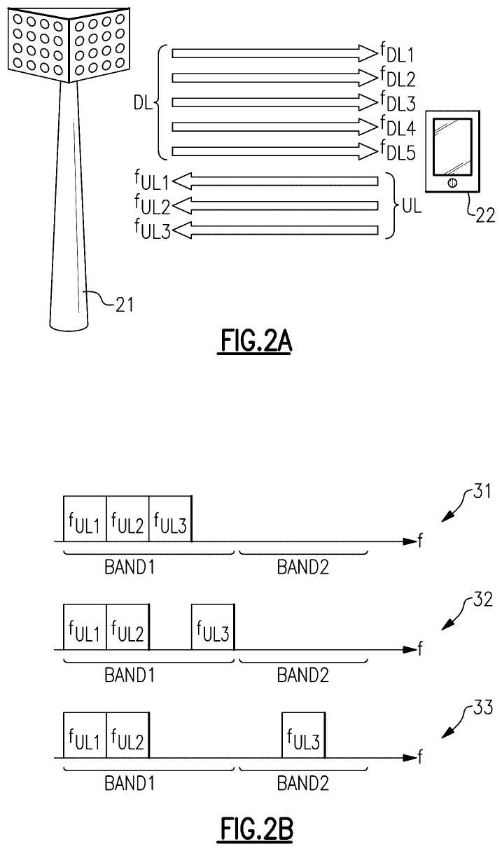

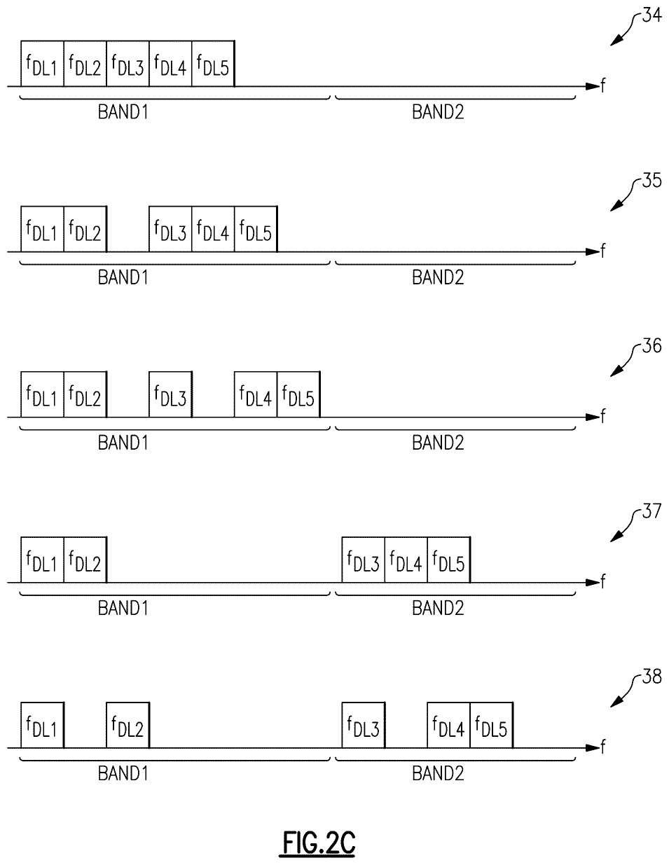

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous and can include carriers separated in frequency within a common band or in different bands.

In the example shown in FIG. 2A, the uplink channel includes three aggregated component carriers f_{UL1}, f_{UL2}, and f_{UL3}. Additionally, the downlink channel includes five aggregated component carriers f_{DL1}, f_{DL2}, f_{DL3}, f_{DL5}, and f_{DL5}. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of uplink carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier f_{UL1}, a second component carrier f_{UL2}, and a third component carrier f_{UL3}. Although FIG. 2B is illustrated in the context of aggregating three component carriers, carrier aggregation can be used to aggregate more or fewer carriers. Moreover, although illustrated in the context of uplink, the aggregation scenarios are also applicable to downlink.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers f_{UL1}, f_{UL2}, and f_{UL3} that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers f_{UL1}, f_{UL2}, and f_{UL3} that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers f_{UL1} and f_{UL2} of a first frequency band BAND1 with component carrier f_{UL3} of a second frequency band BAND2.

FIG. 2C illustrates various examples of downlink carrier aggregation for the communication link of FIG. 2A. The examples depict various carrier aggregation scenarios 34-38 for different spectrum allocations of a first component carrier f_{DL1}, a second component carrier f_{DL2}, a third component carrier f_{DL3}, a fourth component carrier f_{DL4}, and a fifth component carrier f_{DL5}. Although FIG. 2C is illustrated in the context of aggregating five component carriers, carrier aggregation can be used to aggregate more or fewer carriers. Moreover, although illustrated in the context of downlink, the aggregation scenarios are also applicable to uplink.

The first carrier aggregation scenario 34 depicts aggregation of component carriers that are contiguous and located within the same frequency band. Additionally, the second carrier aggregation scenario 35 and the third carrier aggregation scenario 36 illustrates two examples of aggregation that are non-contiguous, but located within the same frequency band. Furthermore, the fourth carrier aggregation scenario 37 and the fifth carrier aggregation scenario 38 illustrates two examples of aggregation in which component carriers that are non-adjacent in frequency and in multiple frequency bands are aggregated. As a number of aggregated component carriers increases, a complexity of possible carrier aggregation scenarios also increases.

With reference to FIGS. 2A-2C, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as WiFi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid WiFi users and/or to coexist with WiFi users. Enhanced license assisted access (eLAA) refers to an evolution of LAA that aggregates licensed and unlicensed spectrum for both downlink and uplink. Furthermore, NR-U can operate on top of LAA/eLAA over a 5 GHz band (5150 to 5925 MHz) and/or a 6 GHz band (5925 MHz to 7125 MHz).

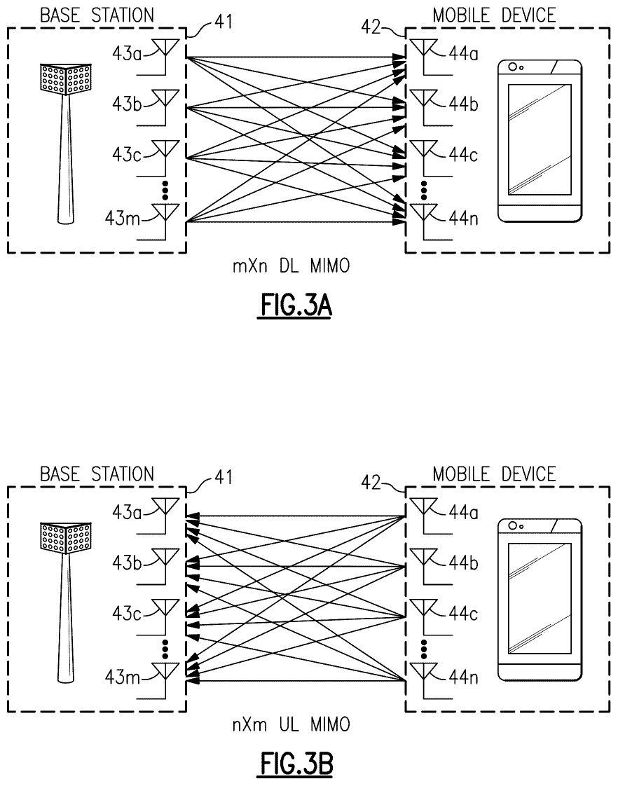

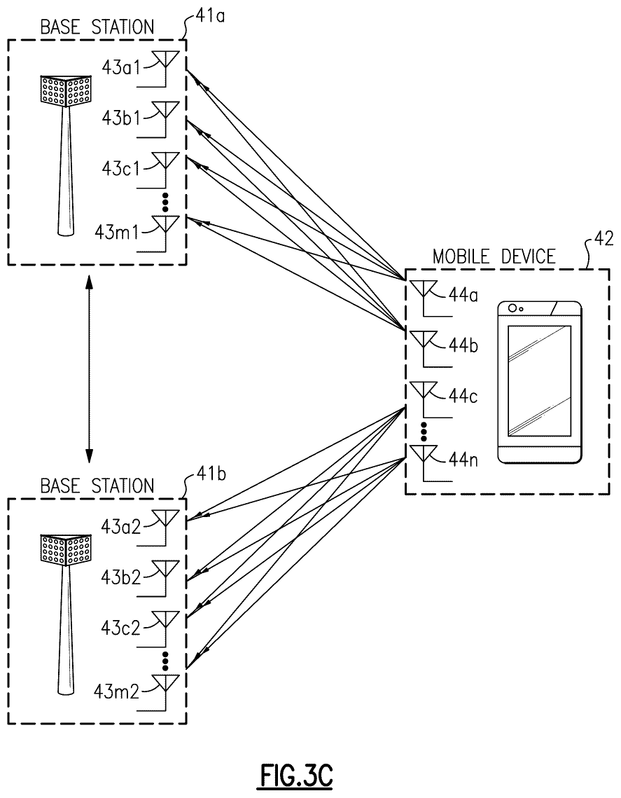

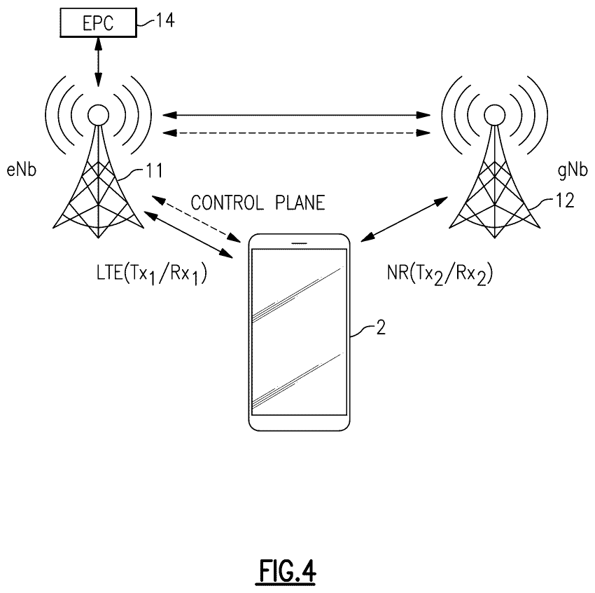

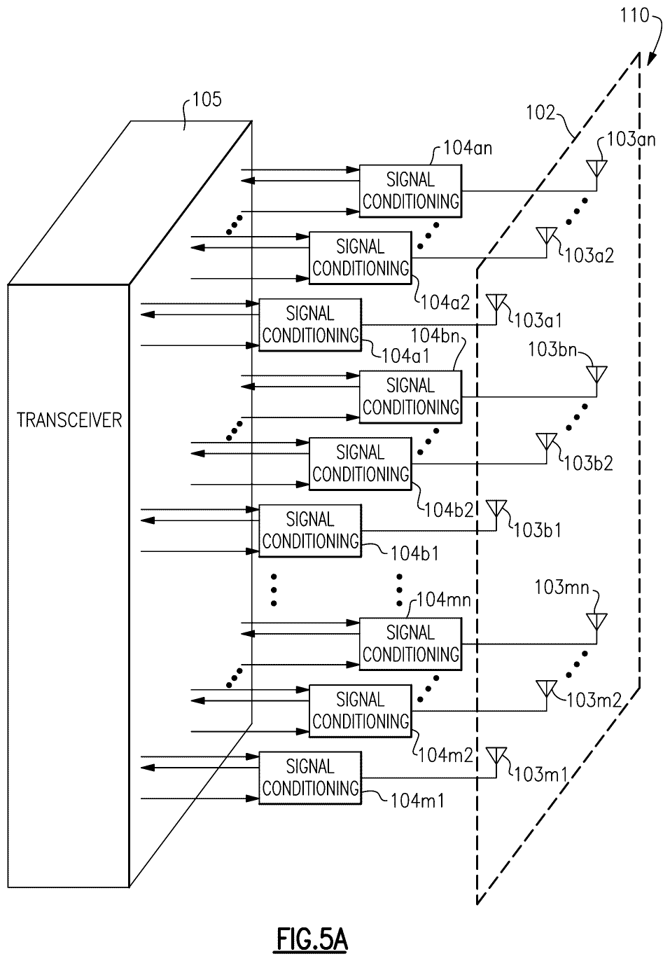

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of m×n DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of n×m UL MIMO.

By increasing the level or order of MIMO, bandwidth of an uplink channel and/or a downlink channel can be increased.

MIMO communications are applicable to communication links of a variety of types, such as FDD communication links and TDD communication links.

FIG. 3C is schematic diagram of another example of an uplink channel using MIMO communications. In the example shown in FIG. 3C, uplink MIMO communications are provided by transmitting using N antennas 44a, 44b, 44c, . . . 44n of the mobile device 42. Additional a first portion of the uplink transmissions are received using M antennas 43a1, 43b1, 43c1, . . . 43m1 of a first base station 41a, while a second portion of the uplink transmissions are received using M antennas 43a2, 43b2, 43c2, . . . 43m2 of a second base station 41b. Additionally, the first base station 41a and the second base station 41b communication with one another over wired, optical, and/or wireless links.

The MIMO scenario of FIG. 3C illustrates an example in which multiple base stations cooperate to facilitate MIMO communications.

FIG. 4 is a schematic diagram of an example dual connectivity network topology. This architecture can leverage LTE legacy coverage to ensure continuity of service delivery and the progressive rollout of 5G cells. A UE 2 can simultaneously transmit dual uplink LTE and NR carrier. The UE 2 can transmit an uplink LTE carrier Tx1 to the eNB 11 while transmitting an uplink NR carrier Tx2 to the gNB 12 to implement dual connectivity. Any suitable combination of uplink carriers Tx1, Tx2 and/or downlink carriers Rx1, Rx2 can be concurrently transmitted via wireless links in the example network topology of FIG. 1. The eNB 11 can provide a connection with a core network, such as an Evolved Packet Core (EPC) 14. The gNB 12 can communicate with the core network via the eNB 11. Control plane data can be wireless communicated between the UE 2 and eNB 11. The eNB 11 can also communicate control plane data with the gNB 12. Control plane data can propagate along the paths of the dashed lines in FIG. 4. The solid lines in FIG. 4 are for data plane paths.

In the example dual connectivity topology of FIG. 4, any suitable combinations of standardized bands and radio access technologies (e.g., FDD, TDD, SUL, SDL) can be wirelessly transmitted and received. This can present technical challenges related to having multiple separate radios and bands functioning in the UE 2. With a TDD LTE anchor point, network operation may be synchronous, in which case the operating modes can be constrained to Tx1/Tx2 and Rx1/Rx2, or asynchronous which can involve Tx1/Tx2, Tx1/Rx2, Rx1/Tx2, Rx1/Rx2. When the LTE anchor is a frequency division duplex (FDD) carrier, the TDD/FDD inter-band operation can involve simultaneous Tx1/Rx1/Tx2 and Tx1/Rx1/Rx2.

As discussed above, EN-DC can involve both 4G and 5G carriers being simultaneously transmitted from a UE. Transmitting both 4G and 5G carriers in a UE, such as a phone, typically involves two power amplifiers (PAs) being active at the same time. Traditionally, having two power amplifiers active simultaneously would involve the placement of one or more additional power amplifiers specifically suited for EN-DC operation. Additional board space and expense is incurred when designing to support such EN-DC/NSA operation.

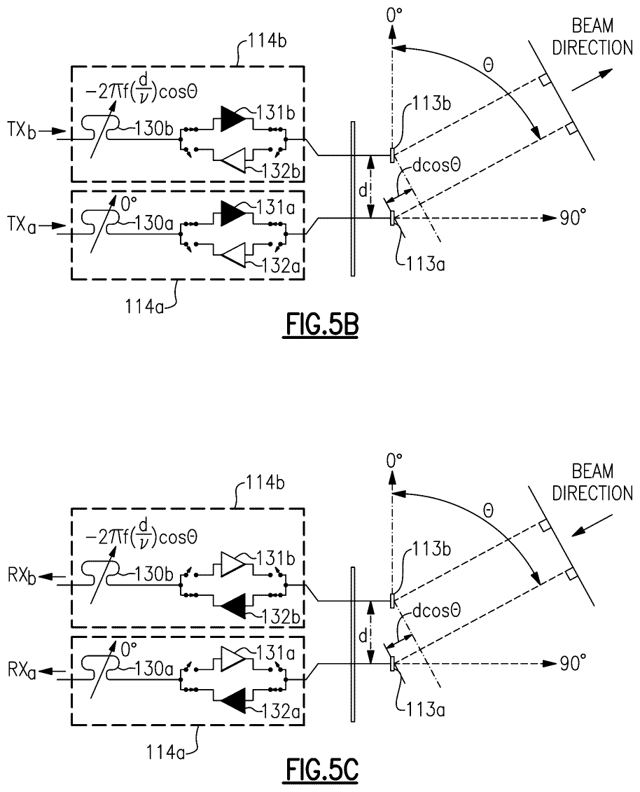

FIG. 5A is a schematic diagram of one example of a communication system 110 that operates with beamforming. The communication system 110 includes a transceiver 105, signal conditioning circuits 104a1, 104a2 . . . 104an, 104b1, 104b2 . . . 104bn, 104m1, 104m2 . . . 104mn, and an antenna array 102 that includes antenna elements 103a1, 103a2 . . . 103an, 103b1, 103b2 . . . 103bn, 103m1, 103m2 . . . 103mn.

Communications systems that communicate using millimeter wave carriers (for instance, 30 GHz to 300 GHz), centimeter wave carriers (for instance, 3 GHz to 30 GHz), and/or other frequency carriers can employ an antenna array to provide beam formation and directivity for transmission and/or reception of signals.

For example, in the illustrated embodiment, the communication system 110 includes an array 102 of m×n antenna elements, which are each controlled by a separate signal conditioning circuit, in this embodiment. As indicated by the ellipses, the communication system 110 can be implemented with any suitable number of antenna elements and signal conditioning circuits.

With respect to signal transmission, the signal conditioning circuits can provide transmit signals to the antenna array 102 such that signals radiated from the antenna elements combine using constructive and destructive interference to generate an aggregate transmit signal exhibiting beam-like qualities with more signal strength propagating in a given direction away from the antenna array 102.

In the context of signal reception, the signal conditioning circuits process the received signals (for instance, by separately controlling received signal phases) such that more signal energy is received when the signal is arriving at the antenna array 102 from a particular direction. Accordingly, the communication system 110 also provides directivity for reception of signals.

The relative concentration of signal energy into a transmit beam or a receive beam can be enhanced by increasing the size of the array. For example, with more signal energy focused into a transmit beam, the signal is able to propagate for a longer range while providing sufficient signal level for RF communications. For instance, a signal with a large proportion of signal energy focused into the transmit beam can exhibit high effective isotropic radiated power (EIRP).

In the illustrated embodiment, the transceiver 105 provides transmit signals to the signal conditioning circuits and processes signals received from the signal conditioning circuits. As shown in FIG. 5A, the transceiver 105 generates control signals for the signal conditioning circuits. The control signals can be used for a variety of functions, such as controlling the gain and phase of transmitted and/or received signals to control beamforming.

FIG. 5B is a schematic diagram of one example of beamforming to provide a transmit beam. FIG. 5B illustrates a portion of a communication system including a first signal conditioning circuit 114a, a second signal conditioning circuit 114b, a first antenna element 113a, and a second antenna element 113b.

Although illustrated as included two antenna elements and two signal conditioning circuits, a communication system can include additional antenna elements and/or signal conditioning circuits. For example, FIG. 5B illustrates one embodiment of a portion of the communication system 110 of FIG. 5A.

The first signal conditioning circuit 114a includes a first phase shifter 130a, a first power amplifier 131a, a first low noise amplifier (LNA) 132a, and switches for controlling selection of the power amplifier 131a or LNA 132a. Additionally, the second signal conditioning circuit 114b includes a second phase shifter 130b, a second power amplifier 131b, a second LNA 132b, and switches for controlling selection of the power amplifier 131b or LNA 132b.

Although one embodiment of signal conditioning circuits is shown, other implementations of signal conditioning circuits are possible. For instance, in one example, a signal conditioning circuit includes one or more band filters, duplexers, and/or other components.

In the illustrated embodiment, the first antenna element 113a and the second antenna element 113b are separated by a distance d. Additionally, FIG. 5B has been annotated with an angle Θ, which in this example has a value of about 90° when the transmit beam direction is substantially perpendicular to a plane of the antenna array and a value of about 0° when the transmit beam direction is substantially parallel to the plane of the antenna array.

By controlling the relative phase of the transmit signals provided to the antenna elements 113a, 113b, a desired transmit beam angle Θ can be achieved. For example, when the first phase shifter 130a has a reference value of 0°, the second phase shifter 130b can be controlled to provide a phase shift of about −2πf(d/v)cosΘ radians, where f is the fundamental frequency of the transmit signal, d is the distance between the antenna elements, v is the velocity of the radiated wave, and π is the mathematic constant pi.

In certain implementations, the distance d is implemented to be about ½λ, where λ is the wavelength of the fundamental component of the transmit signal. In such implementations, the second phase shifter 130b can be controlled to provide a phase shift of about −πcosΘ radians to achieve a transmit beam angle Θ.

Accordingly, the relative phase of the phase shifters 130a, 130b can be controlled to provide transmit beamforming. In certain implementations, a baseband processor and/or a transceiver (for example, the transceiver 105 of FIG. 5A) controls phase values of one or more phase shifters and gain values of one or more controllable amplifiers to control beamforming.

FIG. 5C is a schematic diagram of one example of beamforming to provide a receive beam. FIG. 5C is similar to FIG. 5B, except that FIG. 5C illustrates beamforming in the context of a receive beam rather than a transmit beam.

As shown in FIG. 5C, a relative phase difference between the first phase shifter 130a and the second phase shifter 130b can be selected to about equal to −2πf(d/v)cosΘ radians to achieve a desired receive beam angle Θ. In implementations in which the distance d corresponds to about ½λ, the phase difference can be selected to about equal to −πcosΘ radians to achieve a receive beam angle Θ.

Although various equations for phase values to provide beamforming have been provided, other phase selection values are possible, such as phase values selected based on implementation of an antenna array, implementation of signal conditioning circuits, and/or a radio environment.

### Examples of Radio Frequency Front-End System Architectures

With the proliferation of RF bands in the sub-7 GHz spectrum (ranging from about 3 GHz to about 7.125 GHz in frequency) across cellular and connectivity radios, RFFE architectures have become fragmented and sub-optimal for many of the bands and modes of operation.

Such fragmentation and lack of optimality spans transmit/receive (Tx/Rx) performance, board-level connectivity, power-management subsystems, component count, circuit area, component cost, antenna count, and/or complexity of design for the sub-7 GHz spectrum. These penalties worsen as increasing coexistence specifications come into play and/or evolve.

A variety of types of UE are impacted by these trends, including not only smartphones, but also other types of UE such as customer premises equipment (CPE) and automotive wireless communication modules for smart cars. UE are also referred to herein as mobile devices.

RFFE architectures are disclosed herein. In certain embodiments, RFFEs are disclosed with a high level of integration and component reuse for antennas, power amplifiers (PAs), low noise amplifiers (LNAs), filters, and/or modules.

In certain embodiments, 2 RFFE modules and 6 antennas can cover all sub-7 GHz frequency bands. Such frequency bands can include not only cellular frequency bands, but also frequency bands for WiFi and/or cellular vehicle-to-everything (CV2X).

For example, certain RFFEs (i) co-band WiFi5 (WiFi in the 5 GHz band ranging from about 5.15 GHz to about 5.85 GHz) and cellular n46 (TDD frequency band at about 5.9 GHz); (ii) co-band WiFi6 (WiFi in the 6 GHz band ranging from about 5.925 GHz to about 7.125 GHz), CV2X (in the 5.9 GHz frequency band), and n104 (TDD frequency band ranging between about 6.425 GHz to about 7.125 GHz); and/or (iii) co-band WiFi6, CV2X, n104, and ultra-wideband one (UWB1).

In certain implementations, cellular frequency bands (such as UHB frequency bands) are multiplexed with WiFi5 and WiFi6 bands in a high performance antenna-plexer configuration. Such an antenna-plexer configuration includes splitting of WiFi into 5 GHz and 6 GHz circuitry to enable more efficient co-banding.

Certain RFFEs herein do not cascade any switches post-PA or pre-LNA on any of the frequency bands/paths.

The RFFEs herein use intelligent co-banding to lower PA and LNA count as well as cost and/or area.

Furthermore, certain implementations use co-banding to enable n104 to operate in a two transmit four receive (2T4R) mode (with uplink MIMO or UL-MIMO being possible) with no additional RFFE cost as long as adequate PMIC support is available. Similarly, both CV2X and n46 (NR-U) benefit from 2T2R mode (for instance, Tx diversity for the former and UL-MIMO for the latter) for the same cost as 1T2R.

Moreover, all sub-7 GHz cellular bands support full SRS-AS signaling for channel sounding with little switch overhead. Furthermore, diplexer tunability envisioned can enable tighter filtering and coexistence performance in some scenarios, for example, when (i) CV2X is not needed concurrently with WiFi6, (ii) CV2X is not needed concurrently with WiFi5, and/or (iii) n104, UWB1 or CV2X operation is needed.

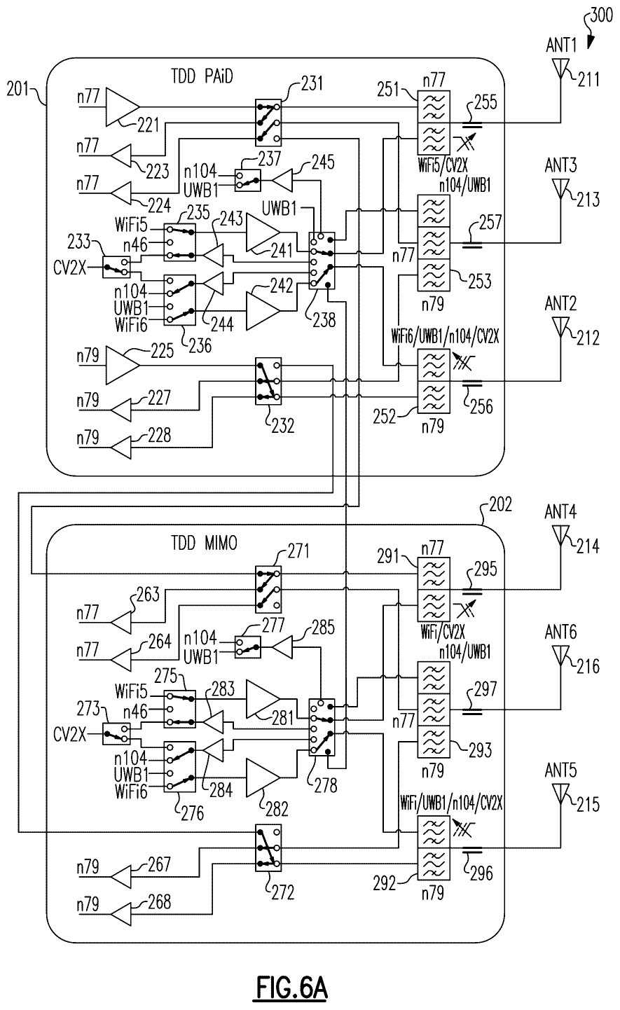

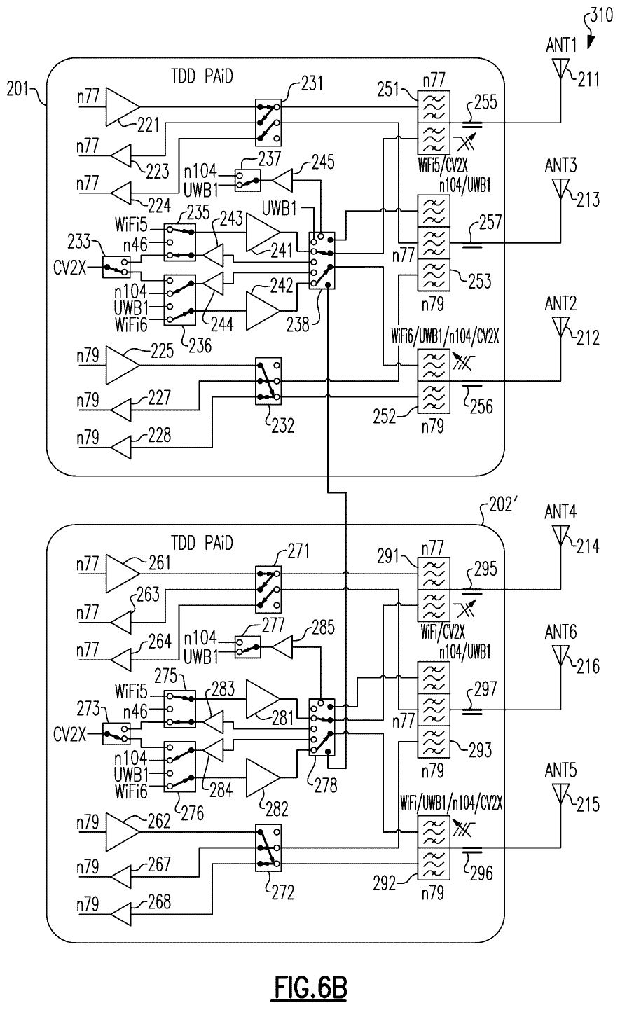

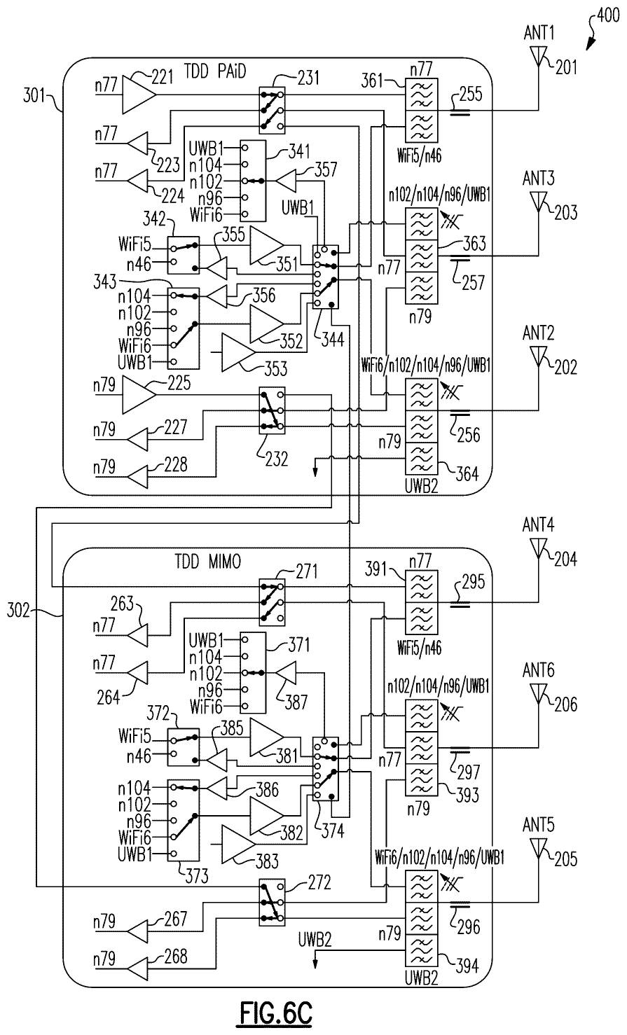

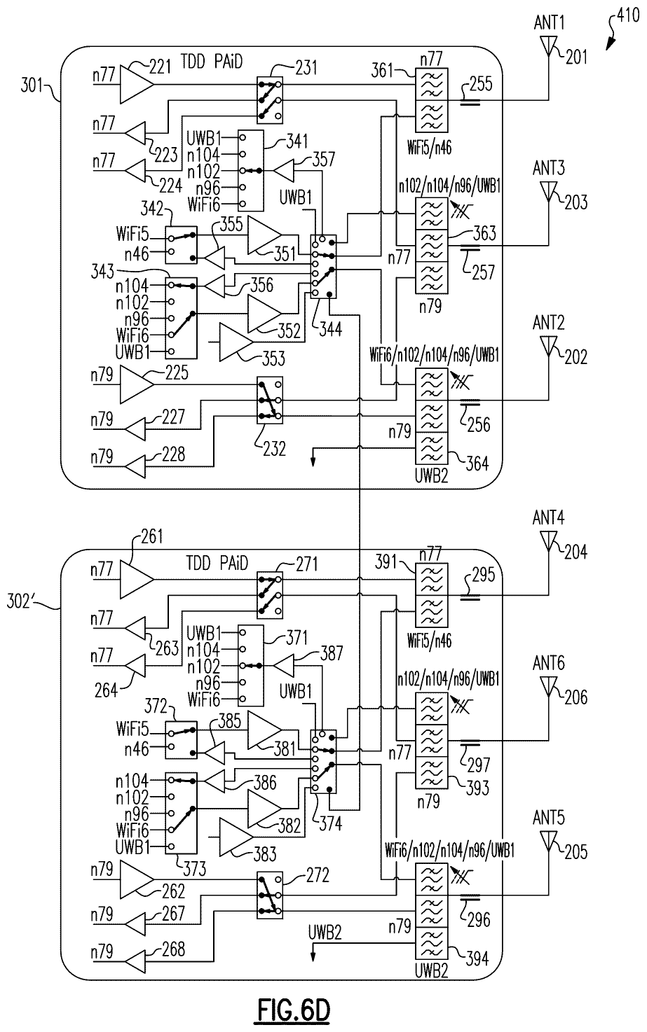

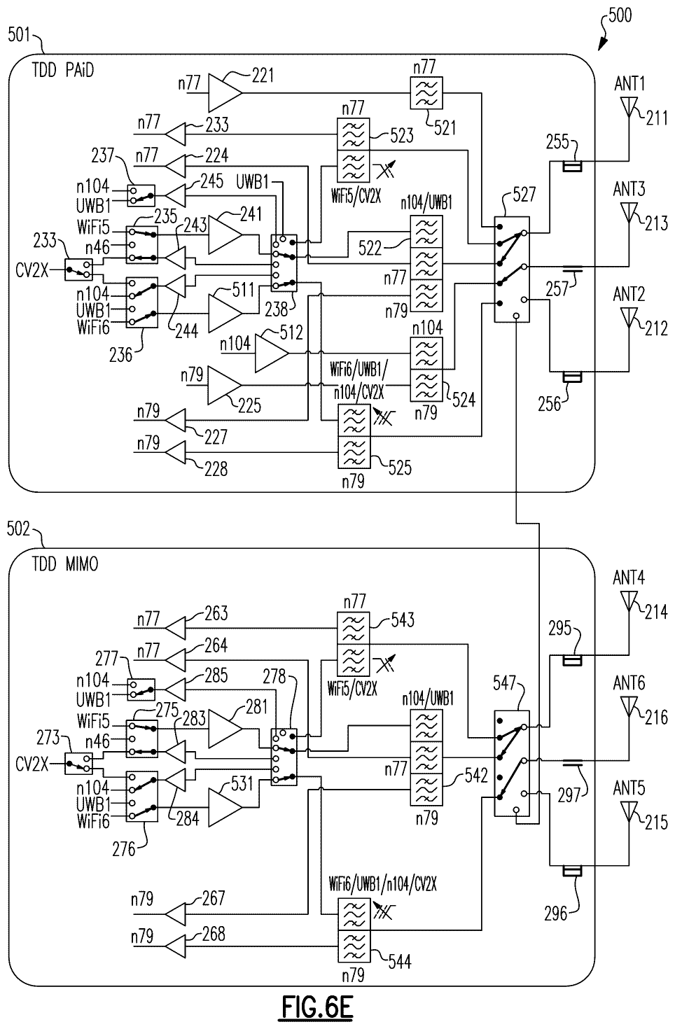

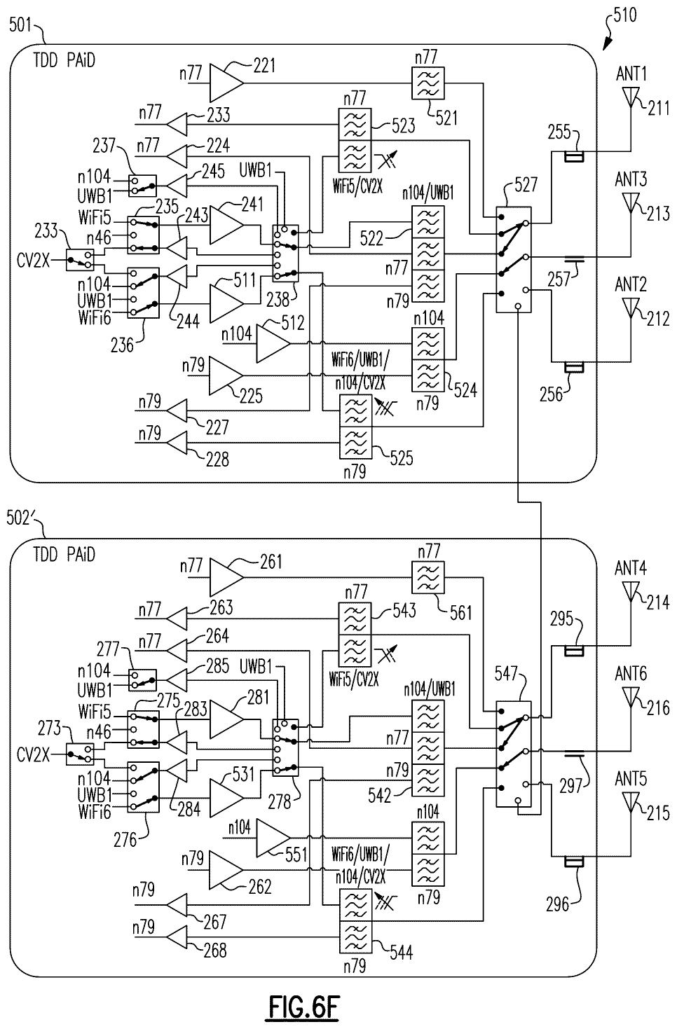

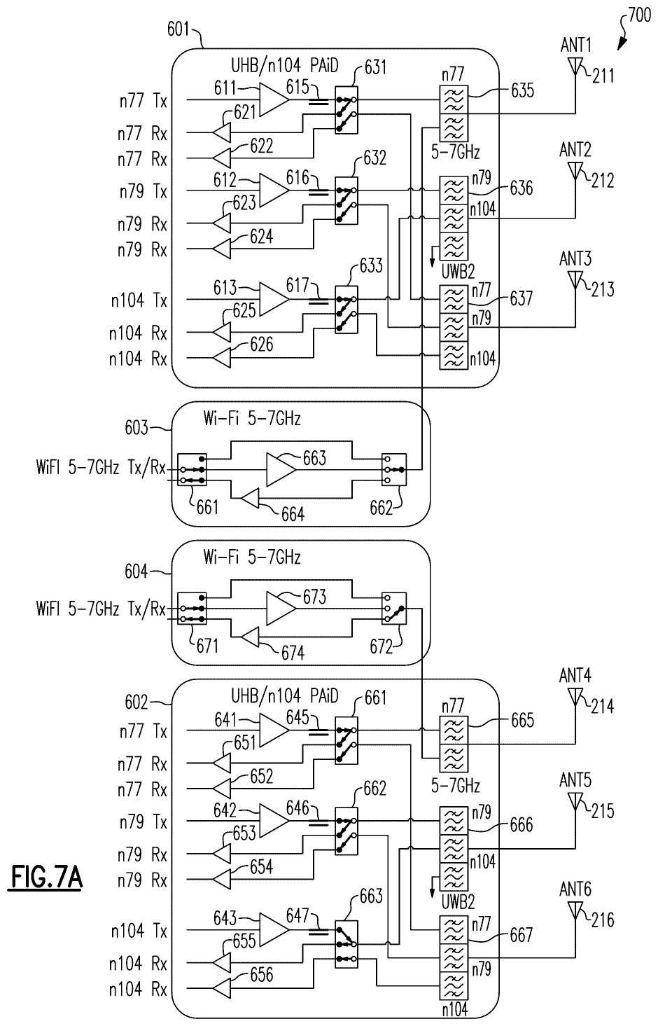

FIG. 6A is a schematic diagram of one embodiment of a front-end system 300. The front-end system 300 includes a first RFFE module 201 (TDD PAiD module), a second RFFE module 202 (TDD MIMO module), a first antenna 211 (ANT1), a second antenna 212 (ANT2), a third antenna 213 (ANT3), a fourth antenna 214 (ANT4), a fifth antenna 215 (ANT5), and a sixth antenna (ANT6).

In the illustrated embodiment, the first RFFE module 201 includes an n77 power amplifier 221, a first n77 LNA 223, a second n77 LNA 224, an n79 power amplifier 225, a first n79 LNA 227, a second n79 LNA 228, a first n77 switch 231, a first n79 switch 232, a first CV2X switch 233, a first WiFi5/n46/CV2X switch 235, a first CV2X/n104/UWB1/WiFi6 switch 236, a first n104/UWB1 switch 237, a first n104/UWB1/WiFi5/n46/CV2X/n104/WiFi6 switch 238, a first WiFi5/n46/CV2X power amplifier 241, a first WiFi6/n104/CV2X power amplifier 242, a first WiFi5/n46/CV2X LNA 243, a first CV2X/n104/UWB1/WiFi6 LNA 244, a first n104/UWB1 LNA 245, a first diplexer 251 (diplexing n77 and WiFi5/CV2X), a second diplexer 252 (diplexing WiFi6/UWB1/n104/CV2X and n79), a first triplexer 253 (triplexing n104/UWB1, n77, and n79), a first coupler 255, a second coupler 256, and a third coupler 257.

With continuing reference to FIG. 6A, the second RFFE module 202 includes a third n77 LNA 263, a fourth n77 LNA 264, a third n79 LNA 267, a fourth n79 LNA 268, a second n77 switch 271, a second n79 switch 272, a second CV2X switch 273, a second WiFi5/n46/CV2X switch 275, a second CV2X/n104/UWB1/WiFi6 switch 276, a second n104/UWB1 switch 277, a second n104/UWB1/WiFi5/n46/CV2X/n104/WiFi6 switch 278, a second WiFi5/n46/CV2X power amplifier 281, a second WiFi6/n104/CV2X power amplifier 282, a second WiFi5/n46/CV2X LNA 283, a second CV2X/n104/UWB1/WiFi6 LNA 284, a second n104/UWB1 LNA 285, a third diplexer 291 (diplexing n77 and WiFi5/CV2X), a fourth diplexer 292 (diplexing WiFi6/UWB1/n104/CV2X and n79), a second triplexer 253 (triplexing n104/UWB1, n77, and n79), a fourth coupler 295, a fifth coupler 296, and a sixth coupler 297.

The front-end system 300 of FIG. 6A provides band support for n77, n79, n104, n46, WiFi5-7, CV2X, and UWB1.

Additionally, the front-end system 300 of FIG. 6A provides transmit/receive (Tx/Rx) support for: (i) n77 and n79 with 2T4R or 1T4R; (ii) n104 with 2T4R; (iii) n46 with 2T2R or 1T2R; (iv) WiFi5 with 2T2R; (v) WiFi6 with 2T2R; (vi) CV2X with 2T2R; and/or (vii) UWB1 with 1T4R.

As shown in FIG. 6A, the front-end system provides support for the depicted bands using 6 antennas (ANT1, ANT2, ANT3, ANT4, ANT5, and ANT6). ANT1, ANT4 cover n77 and (WiFi5 or CV2X). Additionally, ANT2, ANT5 cover n79 and (WiFi6 or n104 or CV2X or UWB1). Furthermore, ANT3, ANT6 covers n77 and n79 and (n104 or UWB1).

The front-end system 300 of FIG. 6A supports carrier aggregation (CA) and simultaneous operation modes (all ULCA/DLCA with 77,79-synch). Such modes include: (i) n77+n79+n104+WiFi5, (ii) n77+n79+WiFi5+WiFi6, (iii) n77+n79+WiFi5+UWB1, (iv) n77+n79+WiFi5+CV2X, (v) n77+n79+WiFi6+CV2X, (vi) n77+n79+n104+CV2X, and (vii) n77+n79+UWB1+CV2X.

Various power amplifiers are co-banded in the embodiment of FIG. 6A. For example, such co-banding includes (i) WiFi5/n46/CV2X−PC3 (5150-5925 MHz); and (ii) WiFi6/n104/CV2X−PC2 (5855-7125 MHz), or WiFi6/CV2X−PC3 (5855-7125 MHz)+n104−PC2 (6425-7125 MHz).

With continuing reference to FIG. 6A, various LNAs are co-banded in this embodiment. For example, such co-banding includes (i) WiFi5/n46/CV2X (5150-5925 MHz); (ii) WiFi6/n104/CV2X/UWB1 (5855-7125 MHz); and (iii) n104/UWB1 (6240-7125 MHz).

In the illustrated embodiment, various switching features are supported. Such switching features include (i) support for SRS-AS channel sounding reference signaling for n77, n79, and n104; (ii) n77, n79: 1T4R SRS or 1T2R×2 SRS; and (iii) n104: 1T4R×2 SRS. Furthermore, the front-end system 300 does not cascade switches post-PA or pre-LNA.

As shown in FIG. 6A, various antenna-plexer features are provided. Such features include one antenna-plexer with small gap (n77-n79), while other antenna-plexers are configured with larger gaps for improved performance. Furthermore, the antenna-plexers are implemented with consideration to the number of Tx tones incident versus possible combinations, and no antenna-plexer sees 2 TX tones for any operation mode unless n77+n79 TX ULCA is configured within a single module).

In certain embodiments, one or more diplexers are tunable. In one example, the n77-WiFi5 diplexer is tunable to extend WiFi5 high corner (for instance, from 5850 MHz to 5925 MHz). In another example, the n79-n104 diplexer is tunable to extend n104 low corner (for instance, from 6425 MHz to 6240, 5925, or 5855 MHz).

The front-end system of FIG. 6A provides a number of features and benefits.

In a first example, the splitting of WiFi into WiFi5 and WiFi6 PAs/LNAs allows for one or more of (i) co-banding of WiFi6 and n104 PAs and LNAs to reduce cost/count; (ii) separation of one n77 and n79 path to different antennas eliminates a need to diplex that path, thereby improving performance/loading without increasing antenna count; (iii) routing of CV2X (which co-bands with both WiFi5 & WiFi6 PAs/LNAs) to either the WiFi5 antenna or the WiFi6 antenna enables coexistence with at least one WiFi band; (iv) simultaneous operation in WiFi5 and WiFi6 is allowed with little overhead; (v) splitting of WiFi filtering into higher-performance diplexers (n77-WiFi5, n79-WiFi6); (vi) rejection of n79 Tx leakage by WiFi6/n104 and/or of WiFi6/n104 Tx noise in n79 Rx will be far better than when WiFi5 and WiFi6 is covered by a single filter; and/or (vii) n79 is still separated from WiFi5 by at least antenna isolation plus one filter attenuation in all operating scenarios. Moreover, these advantages can be provided without increasing the antenna count.

In a second example, a PAiD to MIMO variant is achieved by straightforward depopulation of 2 UHB PAs and possibly one 6 GHz PA. Only 4 switch throws remain superfluous and nothing else needs to be depopulated. As SRS-AS signal is routed out before it passes through the coupler on the PAiD, couplers remain necessary on the MIMO part.

In a third example, Tx swap and 2TAS Rx swap are trivially supported for UHB and n104 bands with only one excess switch connection being needed beyond the minimum achievable with post-LNA swap. Post-LNA swap is thus not justifiable and 4TAS is not supported in this example.

In a fourth example, if the 6 GHz filter in the n77-n79-n104 TPX is extended down to 5945 MHz and the WiFi5 LNA is broad-banded to cover 5-7 GHz, 4×4 DL MIMO on WiFi6 may be supported with minimal additional circuitry for some operation modes.

FIG. 6B is a schematic diagram of another embodiment of a front-end system 310. The front-end system 310 of FIG. 6B is similar to the front-end system 300 of FIG. 6A, except that the front-end system 310 of FIG. 6B is implemented with additional power amplifiers to enable 2T4R support for UHB.

For example, in comparison to the second RFFE module 202 of FIG. 6A, the second RFFE module 202′ (TDD PAiD) of FIG. 6B further includes a second n77 power amplifier 261 and a second n79 power amplifier 262 to enable 2T4R for n77 and n79.

FIG. 6C is a schematic diagram of another embodiment of a front-end system 400. The front-end system 400 includes a first RFFE module 301 (TDD PAiD module), a second RFFE module 302 (TDD MIMO module), a first antenna 211 (ANT1), a second antenna 212 (ANT2), a third antenna 213 (ANT3), a fourth antenna 214 (ANT4), a fifth antenna 215 (ANT5), and a sixth antenna (ANT6). The front-end system 400 includes support for ultra-wideband two (UWB2).

In the illustrated embodiment, the first RFFE module 301 includes an n77 power amplifier 221, a first n77 LNA 223, a second n77 LNA 224, an n79 power amplifier 225, a first n79 LNA 227, a second n79 LNA 228, a first n77 switch 231, a first n79 switch 232, a first UWB1/n104/n102/n96/WiFi6 switch 341, a first WiFi5/n46 switch 342, a first n104/n102/n96/WiFi6/UWB1 switch 343, a first UWB1/n104/n102/n96/WiFi5/WiFi6 switch 344, a first WiFi5/n46 power amplifier 351, a first n102/n104/n96/WiFi6 power amplifier 352, a first n102/n104/n96 power amplifier 353, a first WiFi5/n46 LNA 355, a first WiFi6/UWB1/n102/n104/n96 LNA 356, a first n102/n104/n96/WiFi6/UWB1 LNA 357, a first diplexer 361 (diplexing n77 and WiFi5/n46), a first triplexer 363 (triplexing n102/n104/n96/UBW1, n77, and n79), a second triplexer 364 (triplexing WiFi6/n102/n104/n96/UWB1, n79, and UWB2), a first coupler 255, a second coupler 256, and a third coupler 257.

With continuing reference to FIG. 6C, the second RFFE module 302 includes a third n77 LNA 263, a fourth n77 LNA 264, a third n79 LNA 267, a fourth n79 LNA 268, a second n77 switch 271, a second n79 switch 272, a second UWB1/n104/n102/n96/WiFi6 switch 371, a second WiFi5/n46 switch 372, a second n104/n102/n96/WiFi6/UWB1 switch 373, a second UWB1/n104/n102/n96/WiFi5/WiFi6 switch 374, a second WiFi5/n46 power amplifier 381, a second n102/n104/n96/WiFi6 power amplifier 382, a second n102/n104/n96 power amplifier 383, a second WiFi5/n46 LNA 385, a second WiFi6/UWB1/n102/n104/n96 LNA 386, a second n102/n104/n96/WiFi6/UWB1 LNA 387, a second diplexer 391 (diplexing n77 and WiFi5/n46), a third triplexer 393 (triplexing n102/n104/n96/UBW1, n77, and n79), a fourth triplexer 394 (triplexing WiFi6/n102/n104/n96/UWB1, n79, and UWB2), a fourth coupler 295, a fifth coupler 296, and a sixth coupler 297.

The front-end system 400 of FIG. 6C provides band support for n77, n79, n104, n102, n96, n46, WiFi5, WiFi6, UWB1, and UWB2.

Additionally, the front-end system 400 of FIG. 6C provides Tx/Rx support for (i) n77, n79 with 2T4R or 1T4R (depending on licensed-band SKU); (ii) n104, n102 with 2T4R or 1T4R (depending on licensed-band SKU); (iii) WiFi5 with 2T2R; (iv) WiFi6 with 2T2R; (v) n46 with 2T2R; and/or n96 with 1T4R or 2T4R (depending on PA co-banding choice and licensed-band SKU).

The front-end system 400 of FIG. 6C provides such support using 6 antennas (ANT1, ANT2, ANT3, ANT4, ANT5, and ANT6. Additionally, ANT1, ANT4 covers n77 and (WiFi5 or n46). Furthermore, ANT2, ANT5 cover n79 and (WiFi6 or n104 or n102 or n96). Additionally, ANT3, ANT 6 cover n77 and n79 and (n104 or n102 or n96).

The front-end system 400 of FIG. 6C supports CA and simultaneous operation modes (all ULCA/DLCAA). For simultaneous operation modes, operation of adjacent bands will be limited by filter capability (WiFi5+WiFi6/n102/n96 or WiFi6+n46). All bands in all combinations below can functionally support 2×2UL, subject to how many TX can be active in a module and how many TX can be incident on one antenna-plexer/switch. Such modes can include one or more of (i) n77(4×4D)+n79(4×4D)+n104(4×4D)+WiFi5(2×2D); (ii) n77(4×4D)+n79(4×4D)+WiFi5(2×2D)+WiFi6(2×2D or 4×4D); (iii) n77(4×4D)+n79(4×4D)+WiFi5(2×2D)+n102(4×4D); (iv) n77(4×4D)+n79(4×4D)+n46(2×2D)+n96(4×4D); (v) n77(4×4D)+n79(4×4D)+WiFi5(2×2D)+n96(4×4D); (vi) n77(4×4D)+n79(4×4D)+n46(2×2D)+WiFi6(4×4D); (vii) n77(4×4D)+n79(4×4D)+n46(2×2D)+n102(4×4D); or (viii) n77(4×4D)+n79(4×4D)+n46(2×2D)+n104(4×4D).

Various power amplifiers are co-banded in the depicted embodiment. Such co-banding includes (i) WiFi5/n46−PC3 (5150-5925 MHz); (ii) WiFi6/n96−PC3 (5925-7125MHz); and (iii) n102/n104/n96−PC2 (5925-7125 MHz).

As shown in FIG. 6C, various LNAs are co-banded. Such co-banding includes (i) WiFi6/n104/n102/n96 (5925-7125 MHz); (ii) n102/n104/n96 (5925-7125 MHz); and (iii) WiFi5/n46 (5150-5925 MHz).

Various switching features are supported in FIG. 6C. Such support includes SRS-AS for n77, n79, n104, n102 (with n77, n79 supported for 1T4R SRS or 1T2R×2 SRS, and n104, n102 supported for 1T4R×2 SRS). Additionally, in the illustrated embodiment, there is no cascading of switches post-PA or pre-LNA.

As shown in FIG. 6C, one antenna-plexer with small gap (n77-n79) is provided, while the other antenna-plexers are configured with larger gaps for improved performance. The antenna-plexers are configured with consideration for the number of Tx tones incident versus possible combinations (for instance, no antenna-plexer sees 2 TX tones for any operation mode unless n77+n79 TX ULCA is configured within a single module). In certain implementations, one or more of the antenna-plexers are tunable. In one example, an n79-n104 diplexer is tunable to extend an n104 low corner from 6425 MHz to 6240 MHz to 5925 MHz. In another example, a n77-n79-n104 triplexer is tunable to extend n104 low corner from 6425 MHz to 6240 MHz to 5925 MHz. Tunability confers better isolation between WiFi5 and n104/UWB1 when they are concurrent.

The front-end system 400 of FIG. 6C provide a number of overall features and benefits.

In a first example, splitting of WiFi into WiFi5 and WiFi6 PAs/LNAs plus separation of one n77 and n79 path to different antennas allows one or more of the following advantages: (i) co-banding of WiFi6 with n104/n102 LNAs to reduce cost/count; (ii) eliminating a need to diplex one n77 and n79 path to improve performance/loading without increasing antenna count; (iii) allows simultaneous operation in WiFi5 and WiFi6 (at least 2R) with minimum overhead; (iv) splitting of WiFi filtering into higher-performance diplexers (n77-WiFi5, n79-WiFi6); (v) rejection of n79 Tx leakage by WiFi6/n104/n102, and of WiFi6/n104/n102 Tx noise in n79 Rx will be far better than when WiFi5-7 is covered by a single filter; (vi) n79 is still separated from WiFi5 by at least antenna isolation plus one filter attenuation in all scenarios; and/or (vii) n77+n79 CA can be supported asynchronously (simultaneous Tx/Rx), as long as filters are capable.

In a second example, a PAiD to MIMO variant is achieved by straightforward depopulation of 2 UHB PAs and one 6 GHz PA. Additionally, only 3 switch throws remain superfluous and nothing else needs to be depopulated. As SRS-AS signal is routed out before it passes through the coupler on the PAiD, couplers remain necessary on the MIMO part.

In a third example, Tx swap & 2TAS Rx swap are trivially supported for UHB & n104 bands with only one excess switch connection being needed beyond the minimum achievable with post-LNA swap. Post-LNA swap is thus not justifiable. 4TAS is not supported.

In a fourth example, 4×4 DL MIMO on WiFi6 may be supported with minimal additional circuitry for some operation modes, and STR WiFi5 2TX+WiFi6 4RX can be supported.

FIG. 6D is a schematic diagram of another embodiment of a front-end system 410.

The front-end system 410 of FIG. 6D is similar to the front-end system 400 of FIG. 6C, except that the front-end system 410 of FIG. 6D is implemented with additional power amplifiers to enable 2T4R support for UHB.

For example, in comparison to the second RFFE module 302 of FIG. 6C, the second RFFE module 302′ (TDD PAiD) of FIG. 6D further includes a second n77 power amplifier 261 and a second n79 power amplifier 262 to enable 2T4R for n77 and n79.

FIG. 6E is a schematic diagram of another embodiment of a front-end system 500. The front-end system 500 includes a first RFFE module 501 (TDD PAiD module), a second RFFE module 502 (TDD MIMO module), a first antenna 211 (ANT1), a second antenna 212 (ANT2), a third antenna 213 (ANT3), a fourth antenna 214 (ANT4), a fifth antenna 215 (ANT5), and a sixth antenna (ANT6).

In the illustrated embodiment, the first RFFE module 501 includes an n77 power amplifier 221, a first n77 LNA 223, a second n77 LNA 224, an n79 power amplifier 225, a first n79 LNA 227, a second n79 LNA 228, a first CV2X switch 233, a first WiFi5/n46/CV2X switch 235, a first CV2X/n104/UWB1/WiFi6 switch 236, a first n104/UWB1 switch 237, a first n104/UWB1/WiFi5/n46/CV2X/n104/WiFi6 switch 238, a first WiFi5/n46/CV2X power amplifier 241, a first WiFi6/CV2X power amplifier 511, an n104 power amplifier 512, a first WiFi5/n46/CV2X LNA 243, a first CV2X/n104/UWB1/WiFi6 LNA 244, a first n104/UWB1 LNA 245, an n77 filter 521, a first triplexer 522 (triplexing n104/UWB1, n77, and n79), a first diplexer 523 (diplexing n77 and WiFi5/CV2X), a second diplexer 524 (diplexing n104 and n79), a third diplexer 525 (diplexing WiFi6/UWB1/n104/CV2X and n79), a first antenna switch 527, a first coupler 255, a second coupler 256, and a third coupler 257.

With continuing reference to FIG. 6E, the second RFFE module 502 includes a third n77 LNA 263, a fourth n77 LNA 264, a third n79 LNA 267, a fourth n79 LNA 268, a second CV2X switch 273, a second WiFi5/n46/CV2X switch 275, a second CV2X/n104/UWB1/WiFi6 switch 276, a second n104/UWB1 switch 277, a second n104/UWB1/WiFi5/n46/CV2X/n104/WiFi6 switch 278, a second WiFi5/n46/CV2X power amplifier 281, a second WiFi6/CV2X power amplifier 531, a second WiFi5/n46/CV2X LNA 283, a second CV2X/n104/UWB1/WiFi6 LNA 284, a second n104/UWB1 LNA 285, a second triplexer 542 (triplexing n104/UWB1, n77, and n79), a fourth diplexer 543 (diplexing n77 and WiFi5/CV2X), a fifth diplexer 544 (diplexing WiFi6/UWB1/n104/CV2X and n79), a second antenna switch 547, a fourth coupler 295, a fifth coupler 296, and a sixth coupler 297.

The front-end system 500 of FIG. 6A provides band support for n77, n79, n104, n46, WiFi5-7, CV2X, and UWB1.

In the illustrated embodiment, Tx/Rx support is provided for one or more of (i) n77, n79 with 2T4R or 1T4R; (ii) n104 with 2T4R or 1T4R; (iii) n46 with 2T2R or 1T2R; (iv) WiFi5 with 2T2R; (v) WiFi6 with 2T2R; (vi) CV2X with 2T2R; and/or (vii) UWB1 with 1T4R.

As shown in FIG. 6E, the front-end system 500 interfaces with 6 antennas (ANT1, ANT2, ANT3, ANT4, ANT5, and ANT6). Additionally, ANT1, ANT2, ANT3, ANT4, ANT5, and ANT6 support (i) n77 and (WiFi5 or CV2X); (ii) n79 and (WiFi6 or n104 or CV2X or UWB1); and/or (iii) n77 and n79 and (n104 or UWB1).

The front-end system 500 of FIG. 6E supports CA and simultaneous operation modes (all ULCA/DLCA with 77,79-synch). Such modes include one or more of (i) n77+n79+n104+WiFi5; (ii) n77+n79+WiFi5+WiFi6; (iii) n77+n79+WiFi5+UWB1; (iv) n77+n79+WiFi5+CV2X; (v) n77+n79+WiFi6+CV2X; (vi) n77+n79+n104+CV2X; and/or (vii) n77+n79+UWB1+CV2X.

As shown in FIG. 6E, various PAs are co-banded in this embodiment, including (i) WiFi5/n46/CV2X−PC3 (5150-5925 MHz); and (ii) WiFi6/n104/CV2X−PC2 (5855-7125 MHz), or WiFi6/CV2X−PC3 (5855-7125 MHz)+n104−PC2 (6425-7125 MHz).

With continuing reference to FIG. 6E, various LNAs are co-banded including (i) WiFi5/n46/CV2X (5150-5925 MHz); (ii) WiFi6/n104/CV2X/UWB1 (5855-7125 MHz); and (iii) n104/UWB1 (6240-7125 MHz).

The front-end system 500 of FIG. 6C supports various switching features, including support SRS-AS for n77, n79, and n104. For example, such support includes (i) n77, n79 with 1T4R SRS or 1T2R×2 SRS or 1T4R×2 SRS (with SRS in/out switch); and (ii) n104 with 1T4R×2 SRS. Such switching does not cascade switches post-PA or pre-LNA for cellular bands.

In the illustrated embodiment, various antenna-plexer features are provided. In a first example, one antenna-plexer with small gap (n77-n79) is provided, while other antenna-plexers are configured with larger gaps. In a second example, the antenna-plexers are implemented with consideration with respect to number of Tx tones incident versus possible combinations (with no antenna-plexer seeing 2 TX tones for any operation mode unless 4 TX tones are configured within a single module). In certain implementations, one or more antenna-plexers are implemented with tunability for enhanced performance. In a first example, the n77-WiFi5 diplexer is tunable to extend WiFi5 high corner (for instance, from 5850 MHz to 5925 MHz). In another example, the n79-n104 diplexer is tunable to extend the n104 low corner (for instance, from 6425 MHz to 6240 MHz, 5925 MHz, or 5855 MHz).

The front-end system 500 of FIG. 6E provides various overall features and benefits.

In a first example, splitting of WiFi into WiFi5 and WiFi6 PAs/LNAs provides for one or more of (i) co-banding of WiFi6, n104 PAs and LNAs to reduce cost/count; (ii) separation of one n77 and n79 path to different antennas, eliminating need to diplex that path and improving performance/loading without increasing antenna count; (iii) routing of CV2X (which co-bands with both WiFi5 and WiFi6 PAs/LNAs) to either the WiFi5 antenna or the WiFi6 antennas, enabling coexistence with at least one WiFi band; (iv) simultaneous operation in WiFi5 and WiFi6 with minimum overhead; (v) splitting of WiFi filtering into higher-performance diplexers (n77-WiFi5, n79-WiFi6); (vi) rejection of n79 Tx leakage by WiFi6/n104, and of WiFi6/n104 Tx noise in n79 Rx will be far better than when WiFi5-7 is covered by a single filter; (vii) n79 is still separated from WiFi5 by at least antenna isolation plus one filter attenuation in all scenarios without increasing the antenna count.

In a second example, a PAiD to MIMO variant is achieved by straightforward depopulation of 2 UHB PAs and one 6 GHz PA. Only 3 switch throws remain superfluous and nothing else needs to be depopulated. As SRS-AS signal is routed out before it passes through the coupler on the PAiD, couplers remain necessary on the MIMO part.

In a third example, Tx swap and 2TAS Rx swap are trivially supported for UHB and n104 bands with only one excess switch connection being needed beyond the minimum achievable with post-LNA swap. Post-LNA swap is thus not justifiable. 4TAS is not supported (although it can be with more interconnections on the ASM if desired).

In a fourth example, if the 6 GHz filter in the n77-n79-n104 TPX is extended down to 5945 MHz & the WiFi5 LNA is broad-banded to cover 5-7 GHz, 4×4 DL MIMO on WiFi6 may be supported without additional circuitry for some operation modes.

In a fourth example, coupler count can be reduced from 3 to 2 per PA module & 0 per MIMO module by moving them to dedicated paths before the ASM (to the left in the figure), with known trade-offs to power measurement accuracy on remote antennas.

FIG. 6F is a schematic diagram of another embodiment of a front-end system 510.

The front-end system 510 of FIG. 6F is similar to the front-end system 500 of FIG. 6E, except that the front-end system 510 of FIG. 6F is implemented with additional power amplifiers to enable 2T4R support for UHB and n104.

For example, in comparison to the second RFFE module 502 of FIG. 6E, the second RFFE module 502′ (TDD PAiD) of FIG. 6F further includes a second n77 power amplifier 261, a second n77 filter 561, a second n79 power amplifier 262, a second n104 power amplifier 551, and a sixth diplexer 562 (diplexing n104 and n79).

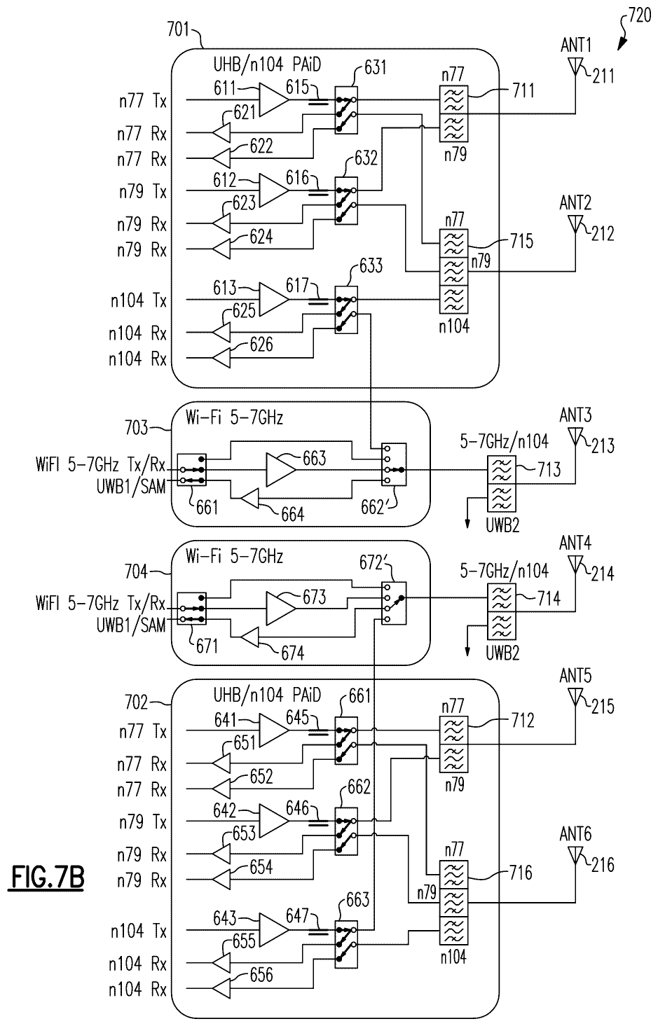

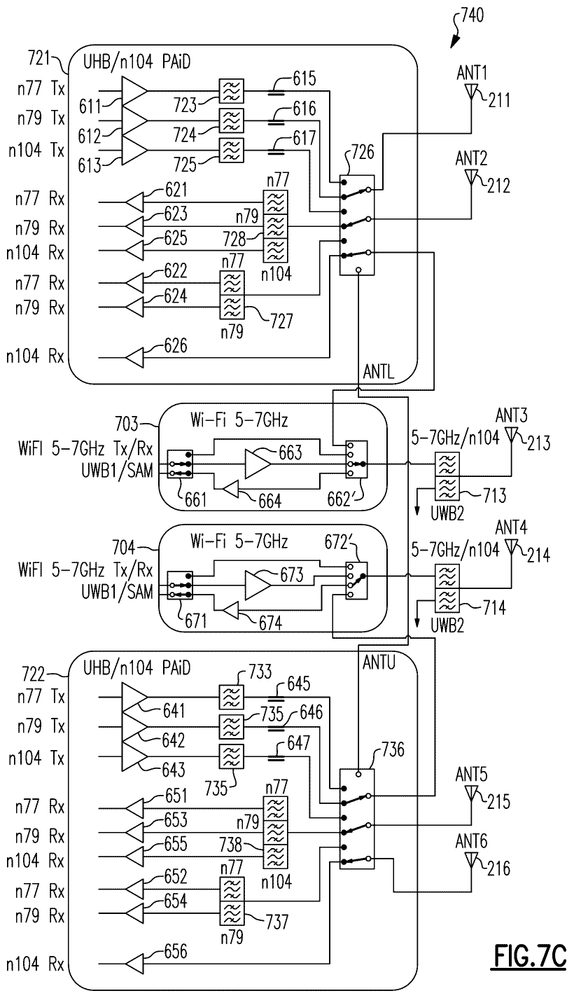

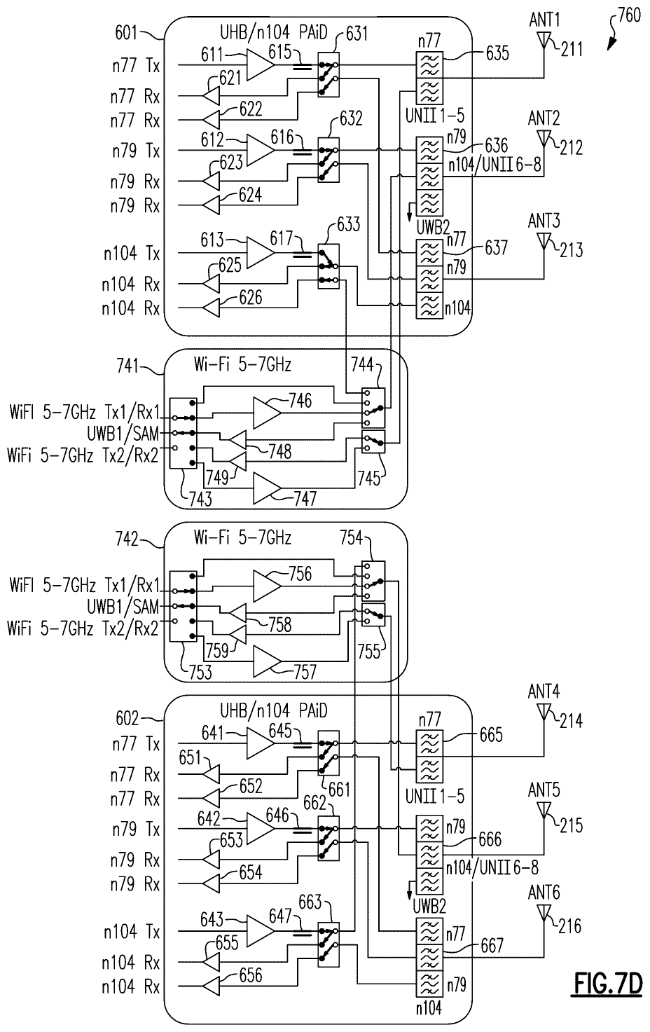

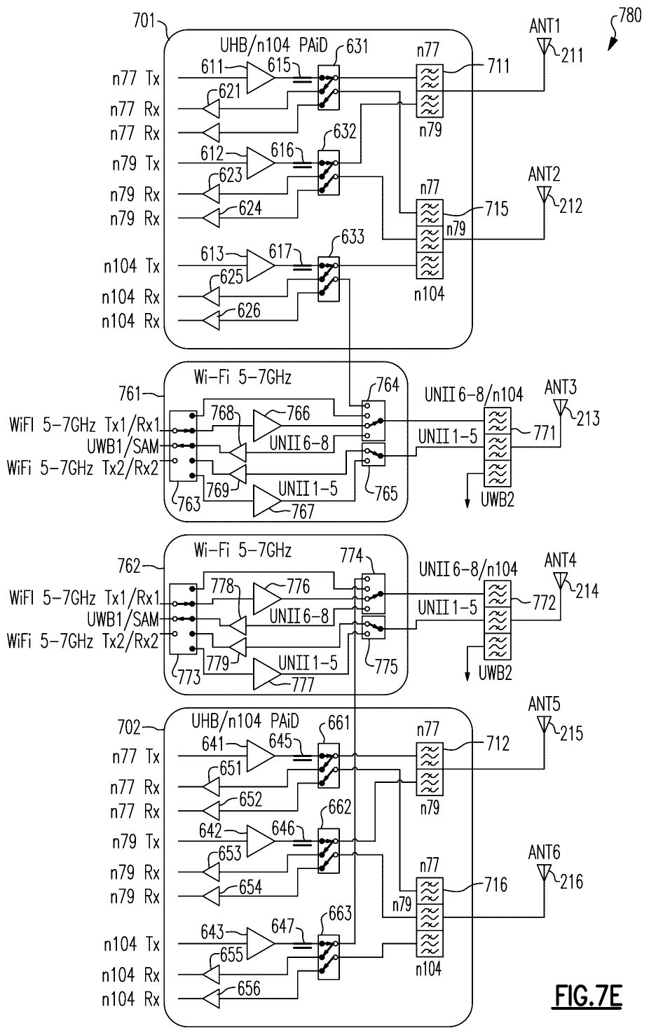

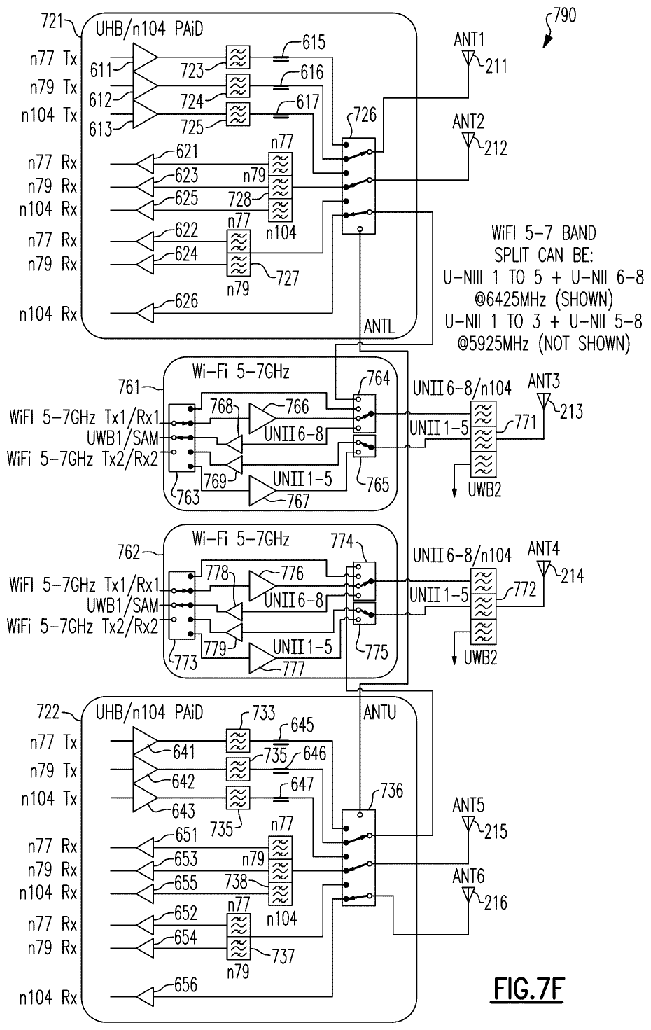

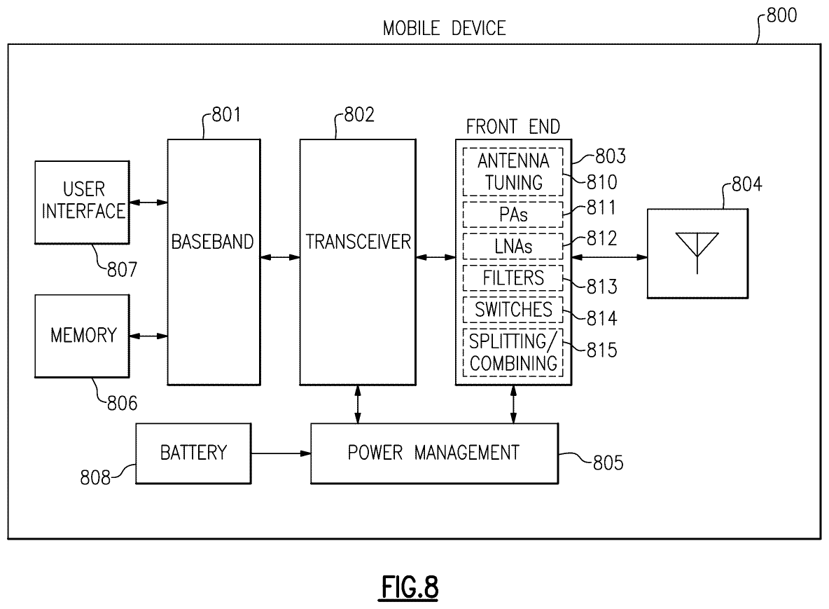

FIG. 7A is a schematic diagram of another embodiment of a front-end system 700. The front-end system 700 includes a first RFFE module 601 (UHB/n104 PAiD), a second RFFE module 602 (UHB/n104 PAiD), a third RFFE module 603 (Wi-Fi 5-7GHz), a fourth RFFE module 604 (W-Fi 5-7GHz), a first antenna 211 (ANT1), a second antenna 212 (ANT2), a third antenna 213 (ANT3), a fourth antenna 214 (ANT4), a fifth antenna 215 (ANT5), and a sixth antenna (ANT6).

In the illustrated embodiment, the first RFFE module 601 includes a first n77 power amplifier 611, a first n79 power amplifier 612, a first n104 power amplifier 613, a first coupler 615, a second coupler 616, a third coupler 617, a first n77 LNA 621, a second n77 LNA 622, a first n79 LNA 623, a second n79 LNA 624, a first n104 LNA 625, a second n104 LNA 626, a first n77 switch 631, a first n79 switch 632, a first n104 switch 633, a first diplexer 635 (diplexing n77 and 5-7 GHz), a first triplexer 636 (triplexing n79, n104, and UWB2), and a second triplexer 637 (triplexing n77, n79, and n104).

With continuing reference to FIG. 7A, the second RFFE module 602 includes a second n77 power amplifier 641, a second n79 power amplifier 642, a second n104 power amplifier 643, a fourth coupler 645, a fifth coupler 646, a sixth coupler 647, a third n77 LNA 651, a fourth n77 LNA 652, a third n79 LNA 653, a fourth n79 LNA 654, a third n104 LNA 655, a fourth n104 LNA 656, a second n77 switch 661, a second n79 switch 662, a second n104 switch 663, a second diplexer 665 (diplexing n77 and 5-7 GHz), a third triplexer 666 (triplexing n79, n104, and UWB2), and a fourth triplexer 667 (triplexing n77, n79, and n104).

In the illustrated embodiment, the third RFFE module 603 includes a first input transmit/receive switch 661 (selecting between WiFi 5-7 GHz and UWB1/SAM), a first output transmit receive switch 662, a first 5-7 GHz power amplifier 663, and a first 5-7 GHz LNA 664. Additionally, the fourth RFFE module 604 includes a second input transmit/receive switch 671 (selecting between WiFi 5-7 GHz and UWB1/SAM), a second output transmit receive switch 672, a second 5-7 GHz power amplifier 673, and a second 5-7 GHz LNA 674.

The front-end system 700 of FIG. 7A supports 2T4R for UHB, 2T4R for n104, and integrated UHB and n104 modules. However, the front-end system provides no concurrent n104+WiFi and no WiFi5/WiFi6 MLO.

FIG. 7B is a schematic diagram of another embodiment of a front-end system 720.

The front-end system 720 includes a first RFFE module 701 (UHB/n104 PAiD), a second RFFE module 702 (UHB/n104 PAiD), a third RFFE module 703 (Wi-Fi 5-7 GHz), a fourth RFFE module 704 (W-Fi 5-7 GHz), a first antenna 211 (ANT1), a second antenna 212 (ANT2), a third antenna 213 (ANT3), a fourth antenna 214 (ANT4), a fifth antenna 215 (ANT5), a sixth antenna (ANT6).

In the illustrated embodiment, the first RFFE module 601 includes a first n77 power amplifier 611, a first n79 power amplifier 612, a first n104 power amplifier 613, a first coupler 615, a second coupler 616, a third coupler 617, a first n77 LNA 621, a second n77 LNA 622, a first n79 LNA 623, a second n79 LNA 624, a first n104 LNA 625, a second n104 LNA 626, a first n77 switch 631, a first n79 switch 632, a first n104 switch 633, a first diplexer 711 (diplexing n77 and n79) and a first triplexer 715 (triplexing n79, n79, and n104). The second RFFE module 602 includes a second n77 power amplifier 641, a second n79 power amplifier 642, a second n104 power amplifier 643, a fourth coupler 645, a fifth coupler 646, a sixth coupler 647, a third n77 LNA 651, a fourth n77 LNA 652, a third n79 LNA 653, a fourth n79 LNA 654, a third n104 LNA 655, a fourth n104 LNA 656, a second n77 switch 661, a second n79 switch 662, a second n104 switch 663, a second diplexer 715 (diplexing n77 and n79), and second triplexer 716 (triplexing n77, n79, and n104).

With continuing reference to FIG. 7B, the third RFFE module 703 includes a first input transmit/receive switch 661 (selecting between WiFi 5-7 GHz and UWB1/SAM), a first output transmit receive switch 662′, a first 5-7 GHz power amplifier 663, and a first 5-7 GHz LNA 664. Additionally, the fourth RFFE module 704 includes a second input transmit/receive switch 671 (selecting between WiFi 5-7 GHz and UWB1/SAM), a second output transmit receive switch 672′, a second 5-7 GHz power amplifier 673, and a second 5-7 GHz LNA 674. A third diplexer 713 provides diplexing between 5-7 GHz/n104 and UWB2, while a fourth diplexer 714 provides diplexing between 5-7 GHz/n104 and UWB2.

The front-end system 720 of FIG. 7B supports 2T4R for UHB, 2T4R for n104, and integrated UHB and n104 modules. However, the front-end system 720 provides no concurrent n104+WiFi and no WiFi5/WiFi6 MLO.

FIG. 7C is a schematic diagram of another embodiment of a front-end system 740.

The front-end system 720 includes a first RFFE module 701 (UHB/n104 PAiD), a second RFFE module 702 (UHB/n104 PAiD), a third RFFE module 703 (Wi-Fi 5-7 GHz), a fourth RFFE module 704 (W-Fi 5-7 GHz), a first antenna 211 (ANT1), a second antenna 212 (ANT2), a third antenna 213 (ANT3), a fourth antenna 214 (ANT4), a fifth antenna 215 (ANT5), a sixth antenna (ANT6).

In the illustrated embodiment, the first RFFE module 721 includes a first n77 power amplifier 611, a first n79 power amplifier 612, a first n104 power amplifier 613, a first coupler 615, a second coupler 616, a third coupler 617, a first n77 LNA 621, a second n77 LNA 622, a first n79 LNA 623, a second n79 LNA 624, a first n104 LNA 625, a second n104 LNA 626, a first n77 filter 723, a first n79 filter 724, a first n104 filter 725, a first antenna switch 726, a first diplexer 727 (diplexing between n77 and n79), and a first triplexer 728 (triplexing between n77, n79, and n104). The second RFFE module 722 includes a second n77 power amplifier 641, a second n79 power amplifier 642, a second n104 power amplifier 643, a fourth coupler 645, a fifth coupler 646, a sixth coupler 647, a third n77 LNA 651, a fourth n77 LNA 652, a third n79 LNA 653, a fourth n79 LNA 654, a third n104 LNA 655, a fourth n104 LNA 656, a second n77 filter 733, a second n79 filter 734, a second n104 filter 735, a second antenna switch 736, a second diplexer 737 (diplexing between n77 and n79), and a second triplexer 738 (triplexing between n77, n79, and n104).

With continuing reference to FIG. 7C, the third RFFE module 703 includes a first input transmit/receive switch 661 (selecting between WiFi 5-7 GHz and UWB1/SAM), a first output transmit receive switch 662′, a first 5-7 GHz power amplifier 663, and a first 5-7 GHz LNA 664. Additionally, the fourth RFFE module 704 includes a second input transmit/receive switch 671 (selecting between WiFi 5-7 GHz and UWB1/SAM), a second output transmit receive switch 672′, a second 5-7 GHz power amplifier 673, and a second 5-7 GHz LNA 674. A third diplexer 713 provides diplexing between 5-7 GHz/n104 and UWB2, while a fourth diplexer 714 provides diplexing between 5-7 GHz/n104 and UWB2.

The front-end system 740 of FIG. 7C supports 2T4R for UHB, 2T4R for n104, and integrated UHB and n104 modules. However, the front-end system 740 provides no concurrent n104 +WiFi and no WiFi5/WiFi6 MLO.

FIG. 7D is a schematic diagram of another embodiment of a front-end system 760. The front-end system 780 includes a first RFFE module 601 (UHB/n104 PAiD), a second RFFE module 602 (UHB/n104 PAiD), a third RFFE module 741 (Wi-Fi 5-7 GHz), a fourth RFFE module 742 (W-Fi 5-7 GHz), a first antenna 211 (ANT1), a second antenna 212 (ANT2), a third antenna 213 (ANT3), a fourth antenna 214 (ANT4), a fifth antenna 215 (ANT5), and a sixth antenna (ANT6).

In the illustrated embodiment, the first RFFE module 601 includes a first n77 power amplifier 611, a first n79 power amplifier 612, a first n104 power amplifier 613, a first coupler 615, a second coupler 616, a third coupler 617, a first n77 LNA 621, a second n77 LNA 622, a first n79 LNA 623, a second n79 LNA 624, a first n104 LNA 625, a second n104 LNA 626, a first n77 switch 631, a first n79 switch 632, a first n104 switch 633, a first diplexer 635 (diplexing n77 and 5-7 GHz), a first triplexer 636 (triplexing n79, n104, and UWB2), and a second triplexer 637 (triplexing n77, n79, and n104). Additionally, the second RFFE module 602 includes a second n77 power amplifier 641, a second n79 power amplifier 642, a second n104 power amplifier 643, a fourth coupler 645, a fifth coupler 646, a sixth coupler 647, a third n77 LNA 651, a fourth n77 LNA 652, a third n79 LNA 653, a fourth n79 LNA 654, a third n104 LNA 655, a fourth n104 LNA 656, a second n77 switch 661, a second n79 switch 662, a second n104 switch 663, a second diplexer 665 (diplexing n77 and 5-7 GHz), a third triplexer 666 (triplexing n79, n104, and UWB2), and a fourth triplexer 667 (triplexing n77, n79, and n104).

With continuing reference to FIG. 7D, the third RFFE module 741 includes a first input transmit/receive switch 743 (selecting between WiFi 5-7 GHz Tx1/Rx1, WiFi 5-7 GHz Tx2/Rx2, and UWB1/SAM), a first output transmit receive switch 744, a second output transmit receive switch 745, a first 5-7 GHz power amplifier 746, a second 5-7 GHz power amplifier 747, a first 5-7 GHz LNA 748, and a second 5-7 GHz LNA 749. Additionally, the fourth RFFE module 742 includes a second input transmit/receive switch 753 (selecting between WiFi 5-7 GHz Tx1/Rx1, WiFi 5-7 GHz Tx2/Rx2, and UWB1/SAM), a third output transmit receive switch 754, a fourth output transmit receive switch 755, a third 5-7 GHz power amplifier 756, a fourth 5-7 GHz power amplifier 757, a third 5-7 GHz LNA 758, and a fourth 5-7 GHz LNA 759.

The front-end system 760 of FIG. 7D supports 2T4R for UHB, 2T4R for n104, and integrated UHB and n104 modules. Additionally, the front-end system 760 of FIG. 7D supports n104 RF thru the WiFi antenna switch (ASM). Furthermore, concurrent n104+WiFi5 and concurrent WiFi5/WiFi6 MLO are supported.

FIG. 7E is a schematic diagram of another embodiment of a front-end system 780.

The front-end system 780 includes a first RFFE module 701 (UHB/n104 PAiD), a second RFFE module 702 (UHB/n104 PAiD), a third RFFE module 761 (Wi-Fi 5-7 GHz), a fourth RFFE module 762 (W-Fi 5-7 GHz), a first antenna 211 (ANT1), a second antenna 212 (ANT2), a third antenna 213 (ANT3), a fourth antenna 214 (ANT4), a fifth antenna 215 (ANT5), a sixth antenna (ANT6).

In the illustrated embodiment, the first RFFE module 601 includes a first n77 power amplifier 611, a first n79 power amplifier 612, a first n104 power amplifier 613, a first coupler 615, a second coupler 616, a third coupler 617, a first n77 LNA 621, a second n77 LNA 622, a first n79 LNA 623, a second n79 LNA 624, a first n104 LNA 625, a second n104 LNA 626, a first n77 switch 631, a first n79 switch 632, a first n104 switch 633, a first diplexer 711 (diplexing n77 and n79) and a first triplexer 715 (triplexing n79, n79, and n104). The second RFFE module 602 includes a second n77 power amplifier 641, a second n79 power amplifier 642, a second n104 power amplifier 643, a fourth coupler 645, a fifth coupler 646, a sixth coupler 647, a third n77 LNA 651, a fourth n77 LNA 652, a third n79 LNA 653, a fourth n79 LNA 654, a third n104 LNA 655, a fourth n104 LNA 656, a second n77 switch 661, a second n79 switch 662, a second n104 switch 663, a second diplexer 715 (diplexing n77 and n79), and second triplexer 716 (triplexing n77, n79, and n104).

With continuing reference to FIG. 7E, the third RFFE module 761 includes a first input transmit/receive switch 763 (selecting between WiFi 5-7 GHz Tx1/Rx1, WiFi 5-7 GHz Tx2/Rx2, and UWB1/SAM), a first output transmit receive switch 764, a second output transmit receive switch 765, a first UNII 6 thru 8 power amplifier 766, a first UNII 1 thru 5 power amplifier 767, a first UNII 6 thru 8 LNA 768, and a first UNII 1 thru 5 LNA 769. Additionally, the fourth RFFE module 762 includes a second input transmit/receive switch 773 (selecting between WiFi 5-7 GHz Tx1/Rx1, WiFi 5-7 GHz Tx2/Rx2, and UWB1/SAM), a third output transmit receive switch 774, a fourth output transmit receive switch 775, a second UNII 6 thru 8 power amplifier 776, a second UNII 1 thru 5 power amplifier 777, a second UNII 6 thru 8 LNA 778, and a second UNII 1 thru 5 LNA 779.

In the illustrated embodiment, a first triplexer 773 triplexes UNII 6-8/n104, UNII 1-5, and UWB2, while a second triplexer 774 triplexes UNII 6-8/n104, UNII 1-5, and UWB2. Although partitioning between UNII 1 thru 5 and UNII 6 thru 8 is shown, other partitioning schemes are possible. In another implementation, partitioning is performed between UNII 1 thru 4 and UNII 5 thru 8.

The front-end system 780 of FIG. 7E supports 2T4R for UHB, 2T4R for n104, and integrated UHB and n104 modules. Additionally, the front-end system 780 of FIG. 7E supports n104 RF thru the WiFi ASM. Furthermore, concurrent n104+WiFi5 and concurrent WiFi5/WiFi6 MLO are supported.

FIG. 7F is a schematic diagram of another embodiment of a front-end system 790.

The front-end system 790 includes a first RFFE module 721 (UHB/n104 PAiD), a second RFFE module 722 (UHB/n104 PAiD), a third RFFE module 761 (Wi-Fi 5-7 GHz), a fourth RFFE module 762 (W-Fi 5-7 GHz), a first antenna 211 (ANT1), a second antenna 212 (ANT2), a third antenna 213 (ANT3), a fourth antenna 214 (ANT4), a fifth antenna 215 (ANT5), a sixth antenna (ANT6).

In the illustrated embodiment, the first RFFE module 721 includes a first n77 power amplifier 611, a first n79 power amplifier 612, a first n104 power amplifier 613, a first coupler 615, a second coupler 616, a third coupler 617, a first n77 LNA 621, a second n77 LNA 622, a first n79 LNA 623, a second n79 LNA 624, a first n104 LNA 625, a second n104 LNA 626, a first n77 filter 723, a first n79 filter 724, a first n104 filter 725, a first antenna switch 726, a first diplexer 727 (diplexing between n77 and n79), and a first triplexer 728 (triplexing between n77, n79, and n104). The second RFFE module 722 includes a second n77 power amplifier 641, a second n79 power amplifier 642, a second n104 power amplifier 643, a fourth coupler 645, a fifth coupler 646, a sixth coupler 647, a third n77 LNA 651, a fourth n77 LNA 652, a third n79 LNA 653, a fourth n79 LNA 654, a third n104 LNA 655, a fourth n104 LNA 656, a second n77 filter 733, a second n79 filter 734, a second n104 filter 735, a second antenna switch 736, a second diplexer 737 (diplexing between n77 and n79), and a second triplexer 738 (triplexing between n77, n79, and n104).

With continuing reference to FIG. 7E, the third RFFE module 761 includes a first input transmit/receive switch 763 (selecting between WiFi 5-7 GHz Tx1/Rx1, WiFi 5-7 GHz Tx2/Rx2, and UWB1/SAM), a first output transmit receive switch 764, a second output transmit receive switch 765, a first UNII 6 thru 8 power amplifier 766, a first UNII 1 thru 5 power amplifier 767, a first UNII 6 thru 8 LNA 768, and a first UNII 1 thru 5 LNA 769. Additionally, the fourth RFFE module 762 includes a second input transmit/receive switch 773 (selecting between WiFi 5-7 GHz Tx1/Rx1, WiFi 5-7 GHz Tx2/Rx2, and UWB1/SAM), a third output transmit receive switch 774, a fourth output transmit receive switch 775, a second UNII 6 thru 8 power amplifier 776, a second UNII 1 thru 5 power amplifier 777, a second UNII 6 thru 8 LNA 778, and a second UNII 1 thru 5 LNA 779.

In the illustrated embodiment, a first triplexer 773 triplexes UNII 6-8/n104, UNII 1-5, and UWB2, while a second triplexer 774 triplexes UNII 6-8/n104, UNII 1-5, and UWB2. Although partitioning between UNII 1 thru 5 and UNII 6 thru 8 is shown, other partitioning schemes are possible. In another implementation, partitioning is performed between UNII 1 thru 4 and UNII 5 thru 8.

The front-end system 790 of FIG. 7F supports 2T4R for UHB, 2T4R for n104, and integrated UHB and n104 modules. Additionally, the front-end system of FIG. 7F supports n104 RF thru the WiFi ASM. Furthermore, concurrent n104+WiFi5 and concurrent WiFi5/WiFi6 MLO are supported.

FIG. 8 is a schematic diagram of one embodiment of a mobile device 800. The mobile device 800 includes a baseband system 801, a transceiver 802, a front-end system 803, antennas 804, a power management system 805, a memory 806, a user interface 807, and a battery 808.

The mobile device 800 can be used communicate using a wide variety of communications technologies, including, but not limited to, 2G, 3G, 4G (including LTE, LTE-Advanced, and LTE-Advanced Pro), 5G NR, WLAN (for instance, WiFi), WPAN (for instance, Bluetooth and ZigBee), WMAN (for instance, WiMax), and/or GPS technologies.

The transceiver 802 generates RF signals for transmission and processes incoming RF signals received from the antennas 804. It will be understood that various functionalities associated with the transmission and receiving of RF signals can be achieved by one or more components that are collectively represented in FIG. 8 as the transceiver 802. In one example, separate components (for instance, separate circuits or dies) can be provided for handling certain types of RF signals. Such separate transceiver circuits or dies can receive separate RF split signals from the front-end systems implemented in accordance with the teachings herein.

The front-end system 803 aids in conditioning signals transmitted to and/or received from the antennas 804. In the illustrated embodiment, the front-end system 803 includes antenna tuning circuitry 810, power amplifiers (PAs) 811, low noise amplifiers (LNAs) 812, filters 813, switches 814, and signal splitting/combining circuitry 815. The front-end system 803 can be implemented in accordance with any of the embodiments herein.

With continuing reference to FIG. 8, the front-end system 803 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 800 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 804 can include antennas used for a wide variety of types of communications. For example, the antennas 804 can include antennas for transmitting and/or receiving signals associated with a wide variety of frequencies and communications standards.

In certain implementations, the antennas 804 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 800 can operate with beamforming in certain implementations. For example, the front-end system 803 can include amplifiers having controllable gain and phase shifters having controllable phase to provide beam formation and directivity for transmission and/or reception of signals using the antennas 804. For example, in the context of signal transmission, the amplitude and phases of the transmit signals provided to the antennas 804 are controlled such that radiated signals from the antennas 804 combine using constructive and destructive interference to generate an aggregate transmit signal exhibiting beam-like qualities with more signal strength propagating in a given direction. In the context of signal reception, the amplitude and phases are controlled such that more signal energy is received when the signal is arriving to the antennas 804 from a particular direction. In certain implementations, the antennas 804 include one or more arrays of antenna elements to enhance beamforming.

The baseband system 801 is coupled to the user interface 807 to facilitate processing of various user input and output (I/O), such as voice and data. The baseband system 801 provides the transceiver 802 with digital representations of transmit signals, which the transceiver 802 processes to generate RF signals for transmission. The baseband system 801 also processes digital representations of received signals provided by the transceiver 802. As shown in FIG. 8, the baseband system 801 is coupled to the memory 806 of facilitate operation of the mobile device 800.

The memory 806 can be used for a wide variety of purposes, such as storing data and/or instructions to facilitate the operation of the mobile device 800 and/or to provide storage of user information.

The power management system 805 provides a number of power management functions of the mobile device 800. In certain implementations, the power management system 805 includes a PA supply control circuit that controls the supply voltages of the power amplifiers 811. For example, the power management system 805 can be configured to change the supply voltage(s) provided to one or more of the power amplifiers 811 to improve efficiency, such as power added efficiency (PAE).

As shown in FIG. 8, the power management system 805 receives a battery voltage from the battery 808. The battery 808 can be any suitable battery for use in the mobile device 800, including, for example, a lithium-ion battery.

### Applications

Some of the embodiments described above have provided examples in connection with mobile devices. However, the principles and advantages of the embodiments can be used for a wide range of RF communication systems. Examples of such RF communication systems include, but are not limited to, mobile phones, tablets, base stations, network access points, customer-premises equipment (CPE), laptops, and wearable electronics.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “may,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A mobile device comprising:
a plurality of antennas including a first antenna, a second antenna, and a third antenna; and
a front-end system including a first antenna-plexer coupled to the first antenna and configured to handle a first cellular frequency band and a first wireless local area network band, a second antenna-plexer coupled to the second antenna and configured to handle a second cellular frequency band and a second wireless local area network band, and a third antenna-plexer coupled to the third antenna and configured to handle the first cellular frequency band and the second cellular frequency band.

2. The mobile device of claim 1 wherein the first cellular frequency band is n77 and the second cellular frequency band is n79.

3. The mobile device of claim 1 wherein the first wireless local area network band is a WiFi 5 gigahertz band and the second wireless local area network band is a WiFi 6 gigahertz band.

4. The mobile device of claim 1 wherein the first antenna-plexer has a high corner for the first wireless local area network band that is tunable.

5. The mobile device of claim 1 wherein the third antenna-plexer further supports a third cellular frequency band.

6. The mobile device of claim 5 wherein the third cellular frequency band is n104 and the second wireless local area network band is a WiFi 6 gigahertz band.

7. The mobile device of claim 6 wherein the front-end system includes at least one of a shared power amplifier or a shared low noise amplifier for amplifying n104 and the WiFi 6 gigahertz band.

8. The mobile device of claim 6 wherein the third antenna-plexer has a low corner for n104 that is tunable.

9. The mobile device of claim 1 wherein the first antenna-plexer is a first diplexer, the second antenna-plexer is a second diplexer, and the third antenna-plexer is a triplexer.

10. The mobile device of claim 1 wherein the plurality of antennas further includes a fourth antenna, a fifth antenna, and a sixth antenna, the front-end system further including a fourth antenna-plexer coupled to the fourth antenna and configured to handle the first cellular frequency band and the first wireless local area network band, a fifth antenna-plexer coupled to the fifth antenna and configured to handle the second cellular frequency band and the second first wireless local area network band, and a sixth antenna-plexer coupled to the sixth antenna and configured to handle the first cellular frequency band and the second cellular frequency band.

11. A method of radio frequency communication, the method comprising:
using a plurality of antennas to communicate over a first cellular frequency band, a first wireless local area network band, a second cellular frequency band, and a second wireless local area network band, the plurality of antennas including a first antenna, a second antenna, and a third antenna;
providing multiplexing of the first cellular frequency band and the first wireless local area network band using a first antenna-plexer coupled to the first antenna;
providing multiplexing of the second cellular frequency band the second wireless local area network band using a second antenna-plexer coupled to the second antenna; and
providing multiplexing of the first cellular frequency band and the second cellular frequency band using a third antenna-plexer coupled to the third antenna.

12. The method of claim 11 wherein the first cellular frequency band is n77 and the second cellular frequency band is n79.

13. The method of claim 11 wherein the first wireless local area network band is a WiFi 5 gigahertz band and the second wireless local area network band is a WiFi 6 gigahertz band.

14. The method of claim 11 wherein the first antenna-plexer has a high corner for the first wireless local area network band that is tunable.

15. The method of claim 11 wherein the third antenna-plexer further supports a third cellular frequency band.

16. The method of claim 15 wherein the third cellular frequency band is n104.

17. The method of claim 16 wherein the third antenna-plexer has a low corner for n104 that is tunable.

18. The method of claim 11 wherein the first antenna-plexer is a first diplexer, the second antenna-plexer is a second diplexer, and the third antenna-plexer is a triplexer.

19. The method of claim 11 wherein the plurality of antennas further includes a fourth antenna, a fifth antenna, and a sixth antenna, the method further comprising using a fourth antenna-plexer that is coupled to the fourth antenna to handle the first cellular frequency band the first wireless local area network band, using a fifth antenna-plexer that is coupled to the fifth antenna to handle the second cellular frequency band and the second wireless local area network band, and using a sixth antenna-plexer coupled to the sixth antenna to handle the first cellular frequency band and the second cellular frequency band.

20. A front-end system for a mobile device, the front-end system comprising:
a first antenna-plexer configured to couple to a first antenna and operable to handle a first cellular frequency band and a first wireless local area network band;
a second antenna-plexer configured to couple to a second antenna and operable to handle a second cellular frequency band and a second wireless local area network band; and
a third antenna-plexer configured to coupled to a third antenna and operable to handle the first cellular frequency band and the second cellular frequency band.

21-50. (canceled)
